(19) United States
(12) Patent Application Publication
(10) Pub. No.: US 2018/0331832 A1
(43) Pub. Date: Nov. 15, 2018

(54) Cryptographic Transactions System

(71) Applicant: Allen Pulsifer, Annapolis Jct, MD (US)

(72) Inventor: Allen Pulsifer, Annapolis Jct, MD (US)

(21) Appl. No.: 15/773,442

(22) PCT Filed: Nov. 4, 2016
(86) PCT No.: PCT/US16/60673

§ 371 Date: May 3, 2018

(51) Int. Cl. H04L 9/32; H04L 9/30; H04L 9/08; H04L 9/06

(52) U.S. Cl. CPC H04L 9/3218; H04L 9/3247; H04L 9/3093; H04L 2209/38; H04L 9/0643; H04L 9/0637; H04L 9/0825

(57) ABSTRACT

This invention is an improved system for processing transactions with a cryptographic currency. The system uses a blockchain protocol as a public record of transactions to ensure only valid tokens can be used as transaction inputs, and that they can be used only once. Witnesses assemble transactions into a blockchain. Once enough witnesses confirm a block, it becomes a permanent and indelible part of the blockchain.

### PRIOR ART

Satoshi Nakamoto (a pseudonym) introduced a system called Bitcoin to track digital tokens. (https://bitcoin.org/bitcoin.pdf). Tokens are represented by an amount and address, where the address is the hash of a digital public signing key. Tokens can be assigned to new addresses by creating a transaction containing one or more input tokens and one or more output tokens, a process sometimes referred to as sending a payment. The transaction must include the public signing key for each input token, and must be digitally signed with the corresponding private key. In addition, the sum of the input token amounts must not exceed the sum of the output token amounts, and all of the input tokens must be “unspent outputs”, where an unspent output is an output of a prior transaction that has not been used as an input in the same or any prior transaction. In order to enforce the latter two rules, all transactions are submitted to a peer-to-peer broadcast network, where one or more network participants called miners receive and validate the transactions, and add them to an ordered list of transactions in a block. Each block created by a miner references a single prior block. The sequence of blocks, from one block to each of the prior blocks in order, forms a blockchain. The miners include with the block an address to which a mining reward is to be paid, then add a nonce of their choice to the block and compute the amount of “work” in the block, a value which equals the hash of the block. In order to be considered a valid block, the work value must be higher than a threshold determined by the nodes on the network. If the resulting block does not contain a sufficient work value, the miner may change the nonce and re-compute the work, repeating this process until a sufficient value is obtained, and then broadcast the resulting block across the network so it is received by all nodes. If the nodes receive more than one sequence of blocks, the sequence with the largest total work is considered the best sequence, where the total work is defined as the sum of the work values for that block and all prior blocks to which it is linked. The blocks in the best sequence and the ordered list of transactions in each block determine an overall sequence for all transactions. When validating transactions, this sequence is used to determine what transaction outputs have appeared in prior transactions, and what outputs have already been used in prior transactions. At any one time, the various nodes in the network might consider different sequences to be the best based on the information they have received from the network. If all blocks are eventually received by all nodes, then they will eventually agree on the best sequence. That sequence is not fixed however—the total work in a chain can be increased by adding more blocks to it. Miners are not required to build a new block on top of the best or the last block in a blockchain—they can build on any block. They might do so based on their mining strategy (to build all the blocks in a segment of the chain so they gain all of the mining rewards), or because they did not see a later block due to network transmission errors or delays. Thus, at times, a node can track one chain as best, and then suddenly switch to a competing chain when a block is added that makes that chain's total work greater. When a switch is made, all of the blocks in the lesser chain are disregarded, and if that chain included transactions not in the new chain, those transactions suddenly go from a spent state to an unspendable state. It is believed in the Bitcoin community that the likelihood of a block being suddenly replaced by an alternate block is inversely exponentially proportional to the length of the chain subsequent to that block. To account for the possibility of a new chain suddenly replacing the existing chain, the Bitcoin community recommends waiting for 6 to 100 “confirmation” blocks before accepting a significant payment. That recommendation is based on assumptions that are not guaranteed by the protocol, and it is possible and allowed by the protocol for the behavior of the blockchain to change unpredictably at any time.

Ben-Sasson, et. al, proposed a modified protocol to make transactions more private (http://zerocash-project.org/media/pdf/zerocash-extended-20140518.pdf). This protocol uses a zero knowledge proving system originally called Pinocchio proposed by Parno, et. al. (http://eprint.iacr.org/2013/279). The Pinocchio system involves a prover and one or more verifiers. The system allows the prover to prove that she knows one or more hidden values known only to herself that, when combined with one or more public values known to all parties, satisfy an agreed upon set of constraints called an arithmetic circuit, which constrains linear combinations of the public and hidden values to all equal zero. The linear combinations allow semantically higher level constraints to be implemented. For example, a value x can be proven to be binary by proving that x*(1−x)=0. A value z can be proven to be the binary AND of x and y by proving that x and y are each binary and that x*y−z=0. A value z can be proven to be the binary OR of x and y by proving that x and y are each binary and that (x+y)−(x*y)−z=0. A value z can be proven to be the binary XOR of x and y by proving that x and y are each binary and that (x+y)−2*(x*y)−z=0. A value z can be proven to be the binary NOT of x by proving that x is binary and (1−x)*z=0. An array of values x[i] can be proven to be the binary decomposition of x into n bits by proving that each x[i] is binary and that the sum(2−i*x[i])−z=0 where the constants 2−i are public inputs. An array of values x[i] and a remainder value r can be proven to be the binary decomposition of x into its n least significant bits with remainder r representing the value the remaining bits by proving that each x[i] is binary and that the sum(c[i]*x[i])+r−z=0. Bitwise binary relationships can be proven by proving that each bit in the binary decomposition of each value satisfies the relationship, for example, z[i]=x[i] AND y[i]. A bit-shifted relationship can be proven using multiplication, for example, z=right-shift-by-2(x) can be proven by x−4*z=0. Bit rotation relationships can be proven by decomposition into bits, and then proving a linear relationship between the bits, for example, proving z=rotate-right-by-1-bit(x) where x is a three-bit value can be proven by proving x[i] is the binary decomposition of x and 4*x[0]+2*x[2]+x[1]−z=0. A conditional constraint can be proven by multiplying a non-conditional constraint by a binary condition, for example, the conditional constraint if x then z=4 can be proven by x*(4−z)=0, and if x is a hidden input or derived from one or more hidden inputs, also proving that x is binary. From these primitives, complex relationships such as z=SHA256(x) can be proven. Membership in a publicly known set can be proven by placing all of the elements in the set into a Merkle hash tree, as described in U.S. Pat. No. 4,309,569, and proving that the prover knows a set of hidden inputs (the inputs on a Merkle tree path) that hash to the publicly known tree root hash value. These techniques are known by persons skilled in the art.

In the Zerocash protocol, tokens are represented by a commitment=SHA256(amount, public signing key, rval) where rval is a randomly chosen value, and a serial number=SHA256(rval). Transactions move tokens from two input serial numbers to two output commitments and, like bitcoin, include the public signing key for each input token, and must be digitally signed with the corresponding private key. A transaction must also include a Merkle tree root hash and a zero knowledge proof that: for each input token, the prover knows a hidden rval such that the published serial number=SHA256(hidden rval) and a hidden commitment=SHA256(hidden input amount, published public signing key, hidden rval); that the hidden commitment is a member of a Merkle tree with the published root hash; for each output token, the prover knows a hidden amount, hidden public signing key and hidden rval such that the published commitment=SHA256(hidden amount, hidden public signing key, hidden rval); and that the sum of the hidden input amounts equals the sum of the hidden output amounts. The public transaction values are submitted to a broadcast network, and used to verify that the transaction's serial numbers have not been used in a prior transaction, and that the transaction's Merkle root hash is a valid value for the tree of commitments at some point in time. Publishing serial numbers for transaction input tokens and commitments for output tokens keeps the relationship between the inputs and outputs private, and the token amounts are kept private by being used only as hidden values in the zero knowledge proving system.

In the Zerocash protocol, the time to create a private transaction can exceed 2 or 3 minutes, depending on the computer used, and it is desired to find a faster method.

The bitcoin proof-of-work method does not guarantee the permanence of any block, since any block can be replaced at any time be providing a sequence of blocks with a higher total proof-of-work. In addition, the probability of a miner finding a sequence with a higher total proof-of-work directly depends on the amount of time expended to find the current best proof-of-work, and therefore decreasing the computation time increases the probability of a block being replaced. It is desirable to create a blockchain system that can quickly guarantee that a block meeting a specified criterion is permanent.

The present invention offers a faster blockchain assembly method that guarantees block permanence, and a faster method of proving private transactions, and includes additional features.

Blockchain Protocol

The system uses a blockchain as a public record of transactions to ensure only valid tokens can be used as transaction inputs, and that they can be used only once. In this system, transactions are assembled into a blockchain by a small number of pre-selected “witnesses”. The system was developed to meet the following goals:
There should be a definitive point in time at which a block becomes permanent and “indelible” and cannot under any circumstances be replaced with another block. Users can then rely on the permanence of transactions inside these blocks when accepting tokens.
All nodes on the system should have the same view of the permanent blockchain; in other words, it should be impossible for two nodes to accept non-identical blocks in what each sees as the indelible part of the blockchain.
Transaction processing should be capable of operating at a high rate of speed, ideally as fast as a dedicated payment processing network.
The system has to operate correctly even in the presence of an unreliable network, which might include delayed and out-of-order delivery of blocks.
It should operate reliably even if some limited number of witnesses go offline, malfunction and generate incorrect blocks, or are taken over and operated maliciously in an effort to subvert the blockchain.
Every node on the network can determine when a block and the blockchain are valid, and when a block is invalid or missing from the blockchain.
It is resistant to forgery and tampering.
It is resistant to denial-of-service attacks.
It is reasonably efficient, i.e., it can meet the speed and security goals without excessive use of computational power.

In order to meet those goals, the following system was created:

1. The first block in the blockchain is a genesis block that is agreed to by all participants.

2. Transactions and blocks are broadcast across a network to which all participants including the witnesses are connected.

3. Each block contains the 512 bit Blake2b hash of the prior block in the blockchain, and a 64-bit level which is set to a value one higher than the prior block. This data uniquely identifies the sequential chain of blocks in the blockchain, while the large hash prevents a witness from replacing a block it created with a different block after another witness has built a block “on top” of it.

4. Each witness signs the blocks it creates using Ed25519-SHA3. When any node on the network receives a block, it rejects any block for which the signature does not verify.

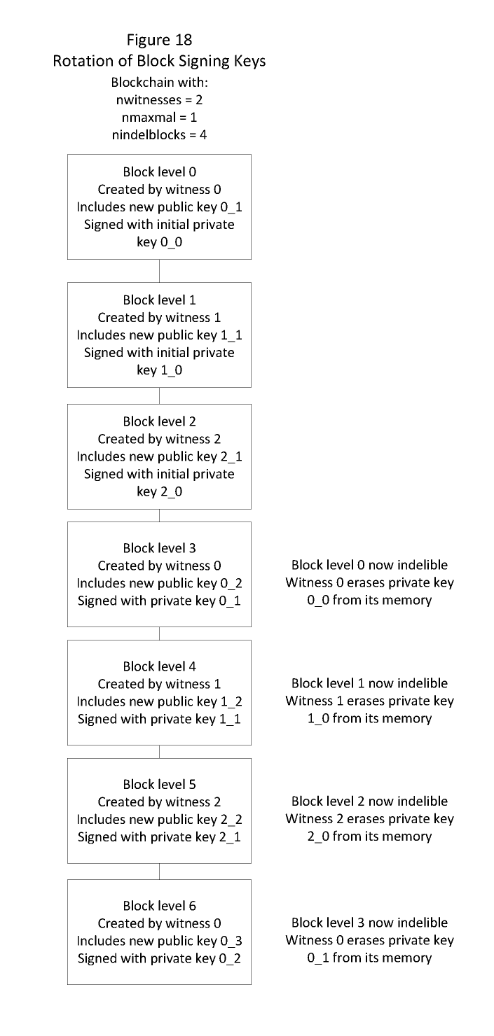

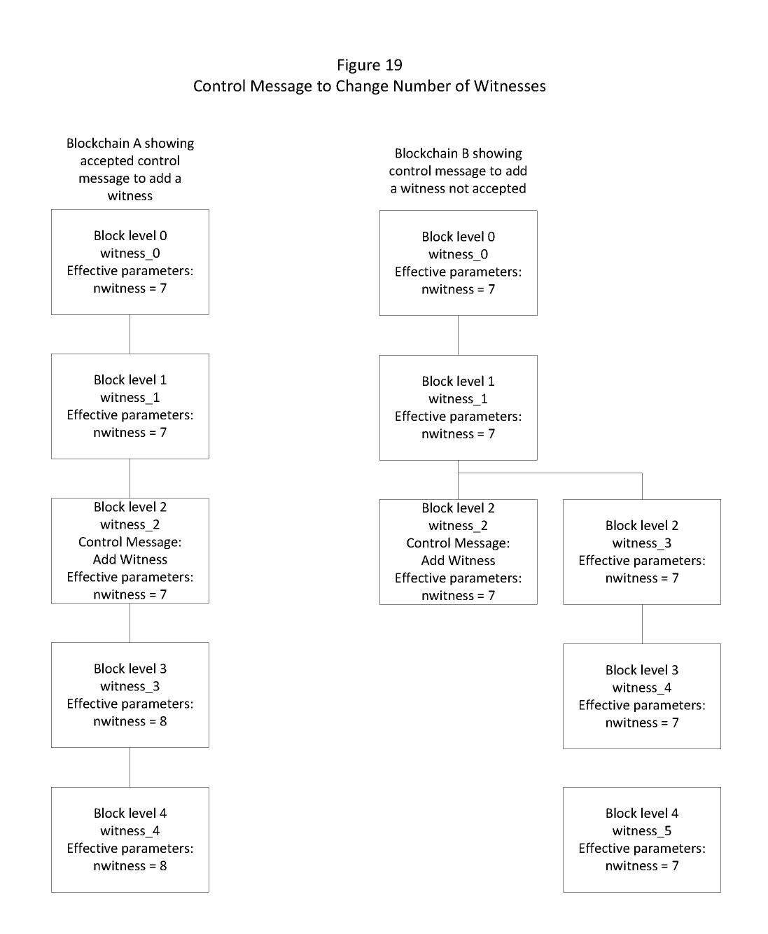

5. The initial public signing key for each witness is pre-programmed in the software that is used to verify the block signatures. When a witness assembles a block, it also generates a new signing key pair it will use to sign the next block in the chain, and includes the public key with the current block. In this way, the signing keys are constantly changing. In addition, as soon as a block becomes indelible (as defined below), the private key used to sign the block is erased from the witness's memory and is gone forever. This makes it difficult for anyone to manipulate the historical record of the blockchain if they were to succeed in obtaining a private signing key. FIG. 18 shows a blockchain with 3 witnesses. Witness 0 generates a block at level 0, and includes with the block a new public signing key 0_1, and uses the corresponding private key 0_1 to sign the block it creates at level 3 that builds on the chain that includes the block at level 0. When the block at level 3 is added to the chain, the block at level 0 becomes indelible, causing Witness 0 to erase private key 0_0 from its memory.

6. The system allows the possibility that, at any point in the blockchain, one or more witnesses might malfunction or be exploited and operated by a malicious party with the goal of executing a double-spend attack or causing the block assembly to malfunction. In the protocol, these malfunctioning or maliciously operated witnesses are referred to as “mal witnesses”.

7. There are two important parameters that control the operation of the blockchain:
nwitnesses:=the number of witnesses that are allowed to create blocks at a particular point in the blockchain.
nmaxmal:=the maximum number of “mal witness” at a particular point in the blockchain that can malfunction or be maliciously operated without affecting the operation of the blockchain.

8. For the system to operate correctly:

nmaxmal<int((nwitnesses+1)/2)

In other words, correct operation cannot be guaranteed if a majority of the witnesses malfunction or are operated maliciously since the mal witnesses could create a blockchain or multiple blockchains that violate the system requirements.

9. From the above two parameters, two additional important parameters are computed:
nconfsigs:=the number of witnesses that need to confirm a block (including the witness that created the block) in order for the blockchain to continue advancing.
nindelblocks:=the number of blocks that need to confirm or built upon a block (including the block itself) in order for the block to become indelible.

10. In the present system, the values of these two parameters are:

nconfsigs=int((nwitnesses−nmaxmal)/2)+1+nmaxmal

nindelblocks=nwitnesses+nmaxmal

11. The first of these parameters, nconfsigs, can be intuitively understood as a majority of the maximum possible number of correctly operating witnesses plus the maximum number of mal witnesses. It might be tempting to say that the blockchain with more than one possible witness should be able to advance with only one correctly operating witness. The problem with that approach is that, due to network transmission errors or delays, two good witnesses might operate without receiving any blocks from the other. If both could proceed, they would produce two completely different blockchains in violation of the requirement that there can be only one authoritative blockchain. In order to ensure every node sees the same valid block chain, the blockchain can only proceed if it contains blocks from a majority of the maximum number of correctly operating witnesses. It then becomes impossible for two different blockchains to exist since only one can contain blocks from a majority of the correctly operating witnesses.

The maximum number of correctly operating witnesses is nwitnesses−nmaxmal, and a majority of the maximum number of correctly witnesses is int((nwitnesses−nmaxmal)/2)+1. To this number we must add the maximum number of mal witnesses. A mal witness may not be following the rules, and may attempt to build on two different blockchains. Since it is not known specifically which witnesses are mal—we are just making an allowance that at any time up to nmaxmal witnesses could malfunction or be exploited—we must account for that by ignoring the contributions of nmaxmal witnesses. The total number of witnesses required to advance the blockchain is therefore int((nwitnesses−nmaxmal)/2)+1+nmaxmal.

12. The value of the nindelblocks parameter can be intuitively understood as the maximum number of correctly operating witnesses, nwitnesses−nmaxmal, plus two times nmaxmal, which is (nwitnesses−nmaxmal)+2*nmaxmal=nwitnesses+nmaxmal. This number arises because a block may be created by a mal witness and then followed in turn by blocks from all the other mal witnesses, by all the correctly operating witnesses, and then again by all the mal witnesses. At that point, the original block has nindelblocks confirmations (including the original block itself), and if the rules for blockchain assembly set forth below are followed, no chain that competes with the original block can advance as far, and therefore the block with nindelblocks “confirmations” has become indelible since it is in the only chain that can continue to advance.

13. It is possible for the values of these parameters to vary over time, i.e., witnesses can be added or removed and the allowance for mal witnesses can be increased or decreased. These parameters can be varied by inserting a control message in a block, and become effective for all blocks built on top of the block containing the control message. If any other witness does not agree with the change, it can refuse to build on the chain that contains the control message, and instead build on one of its predecessor blocks. If fewer than nconfsigs witnesses are willing to agree to the change, the chain containing the control message will not advance since blockchain advancement requires the agreement of at least nconfsigs witnesses. FIG. 18 shows a blockchain A with a control message to add a witness inserted into the block at level 3 created by witness_2. This control message is accepted by witness_3 and witness_4 who vote in favor of the change by creating new blocks in the chain that include the control message. The control message becomes effective in the block following the block that contains the message. FIG. 18 also shows a blockchain B where the control message is not accepted by the other witnesses, and indicate their non-acceptance by not building new blocks in the chain that includes the control message.

14. For the purpose of describing the rules below, each witness is assigned an integer witness number called witness_id from 0 to nwitnesses−1 inclusive. Each block is also assigned a witness_id, which equals the witness_id of the witness that creates the block.

15. The simplest possible implementation of blockchain assembly using a set of witnesses would be to have the witnesses operate round-robin, each creating a block in turn and adding it to the blockchain, so that for every block, the witness_id would equal the prior block's witness_id+1 modulo nwitnesses. However, that system would come to a halt if one of the witnesses for any reason did not build a valid block. In order to continue advancement of the blockchain when some number of witnesses are not operational, the system must allow for skips in the witness_id sequence.

16. Let the skip between two consecutive blocks be defined as:

skip=(next−((prev+1)nwitnesses))% nwitnesses
where prev:=the witness_id of the earlier block in the chain
and next:=the witness_id of the later block in the chain

From this definition, if two blocks have consecutive witness_id's (for example, 0 and 1) then the skip is zero. If the witness_id's differ by 2, then the skip is 1, etc.

17. Unique Signatures Rule: The system does not allow arbitrary skips in the witness_id sequence. In order for a block to be valid, the sum of the nconfsigs−1 skips that immediately precede the block (including the skip between it and its predecessor) must be less than or equal to nwitnesses:

sum(skip[i]) over the nconfsigs−1 skips preceding the block<=nwitnesses

If a block violates that rule, it is invalid and discarded. Any number of witnesses can attempt to violate this rule without affecting the integrity of the blockchain since the blocks that violate this rule will be rejected by the other nodes in the system.

18. The Unique Signatures Rule ensures no witness can create more than one block within any span of nconfsigs blocks. More importantly, it means that for every block, the next nconfsigs−1 blocks will come from different witnesses, so that after nconfsigs−1 additional blocks, the original block will have been confirmed by nconfsigs different witnesses (including the witness that created the block). This rule prevents one or a small number of witnesses acting alone to advance the blockchain. In order for the blockchain to advance, at least nconfsigs different witnesses need to be operational and agree on the blocks to be added. This property is required to ensure the blockchain assembly operates correctly even in the presence of network transmission delays.

19. The Unique Signatures Rule also imposes an ordering property that causes the block witness_id's to be ascending modulo nwitnesses, i.e., for all blocks in a span of nconfsigs blocks, the skip must be <=nwitnesses−nconfsigs. While enforcement of this property by itself is not required for correct operation, the ordering property ensures no block will be added to a chain if the skip from that block would result in a chain that would eventually come to an end due to the nconfsigs different witnesses requirement; in other words, the ordering property imposed by that rule prevents the system from pursuing dead end chains.

20. The witnesses must also nominally adhere to the following rules. The word “nominally” is used because up to nmaxmal witnesses can violate the following rules without affecting the validity of the blockchain:

21. Chain to Indelible Rule: A witness may only build a block on top of a chain that ends in or leads back to the most recent indelible block. In other words, if two competing chains exist, and the blockchain advances to the point that the earliest block in one of the two chains becomes indelible, the other chain must be disregarded and not further built upon. This rule ensures the witnesses acting as a group will not attempt to replace an indelible block.

Note however that for this and for all rules, a witness is only required to act based on the blocks it has received; it is not required to act based on blocks that may have been created by other witnesses but it has not yet received due to network transmission delays. For example, using the prior rule, one witness may believe a block in one of the two competing chains has become indelible based on the arrival of a new block, while a second witness that has not yet received the new block may continue to build on either chain because that witness does not yet consider the prior block to be indelible. This situation does not violate the rules—a witness is only required to act on the blocks that it has seen, not on blocks it has not yet received.

22. Better Path Rule: A witness will only create a block that has a “better” path than any previous block it has created on a chain that leads back to the most recent indelible block. A path is better when it has a lower “skip score” which is defined as the string of skips concatenated together from left to right starting from the most recent indelible block and ending at the block of interest. Scores are compared from left to right and the lower score is the one with the lower skip at the left-most position at which the strings differ. If the strings do not differ at any position, then the longer string has the lower score.

23. The Better Path Rule allows a witness to begin building on a lower score path than it has built on previously, but it prohibits a witness to begin or continue to build on a higher score path after it has built on a lower score path. This prevents the witnesses as a group from building indefinitely on more than one competing path, since once a majority of witnesses have built on the lower score path, they can no longer build on the higher score path.

24. Note that as the blockchain advances, if a block that a witness created no longer chains back to the most recently indelible block, that block is no longer used to compute the witness's best previous skip score. As a result, if a majority of the witnesses choose a higher score path, the witnesses who built on a lower score path will begin to follow the majority after the blockchain has advanced and the lower score path no longer chains back to the most recently indelible block.

25. Increasing Level Rule: A witness will only build a block at a higher level than the block it last created. In other words, if a witness created a block at level 204 on one chain, it will not subsequently create a block at level 204 or lower on that or any other chain. This rule works in conjunction with the Better Path Rule to ensure the witnesses choose a single path for the blockchain.

26. Note that up to nmaxmal witnesses can violate the above rules without affecting the correct operation of the blockchain. If more than nmaxmal witnesses violate the rules, then more than one block at the same level may appear to become indelible. The other nodes in the system will detect the conflicting indelible blocks and immediately halt any further acceptance of blocks and advancement of the blockchain until the issue is resolved. All nodes on the network therefore work together to keep the witnesses “honest” and ensure they operate correctly.

The rules described above are sufficient for correct operation of the blockchain. There are however a few aspects left to describe.

27. The Better Path Rule allows a witness to create a block at any location as long as the skip score of the new block is lower than all blocks the witness has previously created that chain back to the last indelible block. Under this rule then, if a witness can create blocks at more than one location in the block chain, it can choose any of those locations regardless of their relative skip scores. While not required for proper operation, the blockchain advances faster and more efficiently (i.e., with fewer sidechains) if all witnesses, when they have a choice, always create the block with the lowest possible skip score.

28. The rules do not require any particular ordering of the witness work—the witnesses could all build blocks simultaneously wherever permitted by the above rules. That would however lead to all nodes in the system validating multiple blocks to find the best possible path forward. It is more efficient for the witnesses to go round-robin to the extent possible. In such a protocol, a nominal block rate could be chosen, for example, one block every two seconds. The witnesses would then go in turn, with each witness creating a block two seconds after the prior witness. If a witness fails to generate a block, the next witness in order would wait for its turn based on the block rate and then create a block. If there were no work to do, i.e., there were no transactions that had yet to be added to blocks and no blocks containing transactions that had yet become indelible, then all witnesses could pause and wait to receive a transaction. When one is received, they would all restart their clocks and resume the witness sequence where it left off.

29. In the event a witness crashes or needs to be restarted, the remaining witnesses can send a block containing a control message to first drop that witness and then to add another witness. The “add a witness” message would include the new witness's public block signing key.

30. The protocol above can run in the steady state with only nconfsigs witnesses generating valid blocks. If however more than nconfsigs witnesses go offline, the system needs a method to resume operation. To address this, each witness is also associated with a key pair that can be used to sign a reset block. The public key is preprogrammed in the network node software while the private key is kept on an air-gapped host. If required, a reset block containing a new block signing public key is created on the air-gapped host and then securely transferred to the network. This is repeated for as many witnesses as necessary to resume operation.

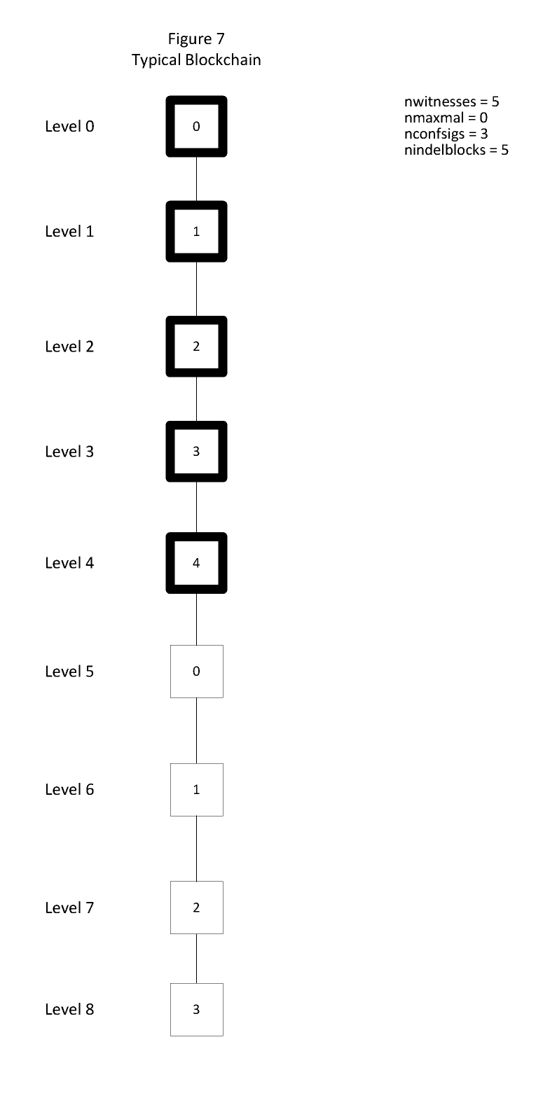

31. FIG. 7 shows how a blockchain might look using the preferred embodiment if all witnesses are working properly. Each block is labeled with its witness_id and the blocks with thicker outlines are indelible. The block at Level 4 for example was created by witness_id 4 and is indelible because it has nindelblocks=5 confirmations from witness's 4, 0, 1, 2 and 3 at Levels 4 through 8 inclusive.

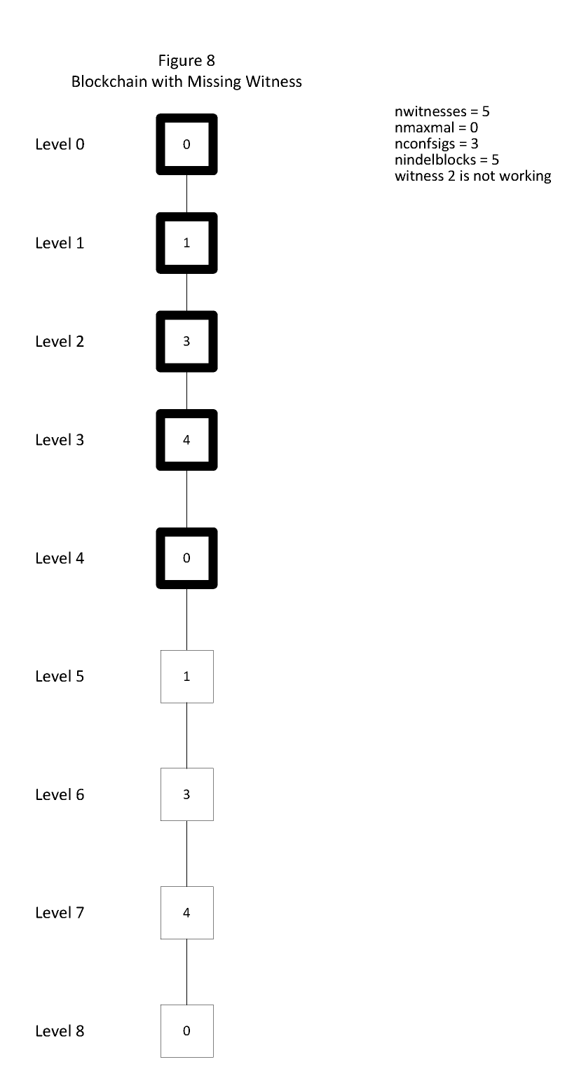

32. FIG. 8 shows how a blockchain might look if witness_2 is not working and unable to generate valid blocks causing witness_2 to be skipped and the blockchain to go from witness 1 to witness 3.

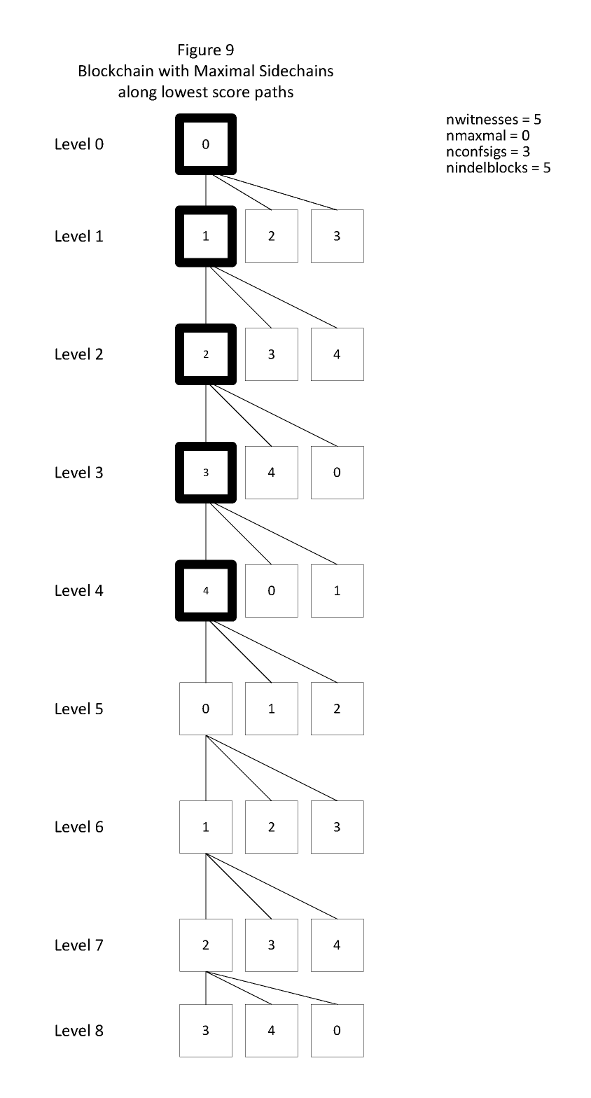

33. FIG. 9 shows how a blockchain might look if the witnesses all attempted to create as many blocks as allowed along the lower score branches. Witness 3 has created blocks as Levels 1, 2 and 3, with the block at Level 1 on a lower scoring chain than the blocks on Levels 2 and 3. This is allowed and adheres to both the Better Path and Increasing Level rules as long as the block at level 1 is created first, then the blocks at level 2, then the block at level 1.

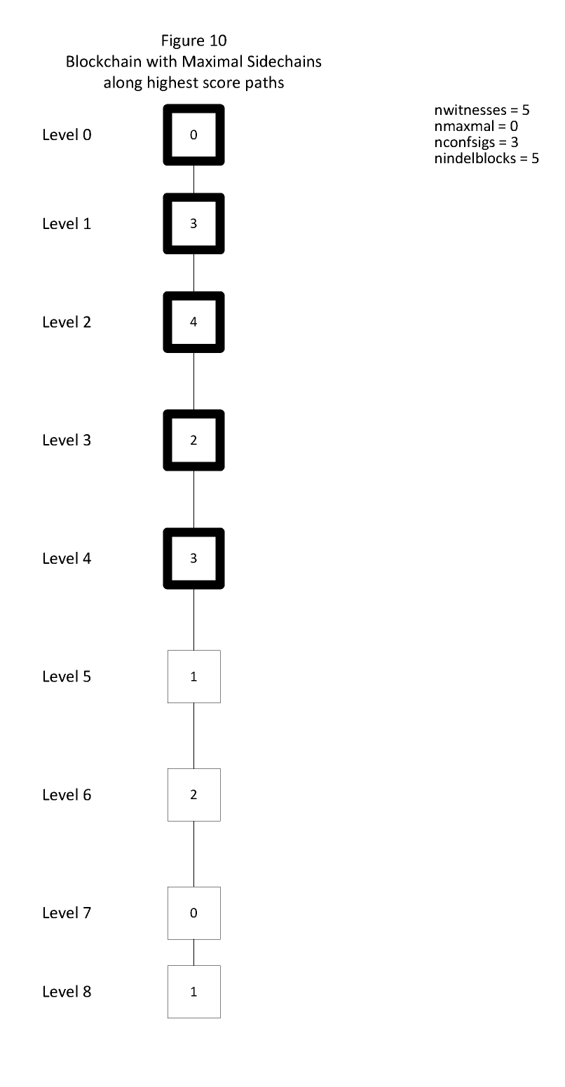

34. FIG. 10 shows how a blockchain might look if the witnesses all attempted to create as many blocks as allowed along the higher score branches. The blockchain is linear in this example because the Better Path Rule does not allow a witness to create a block on lower score chain and then continuing building on a higher score chain.

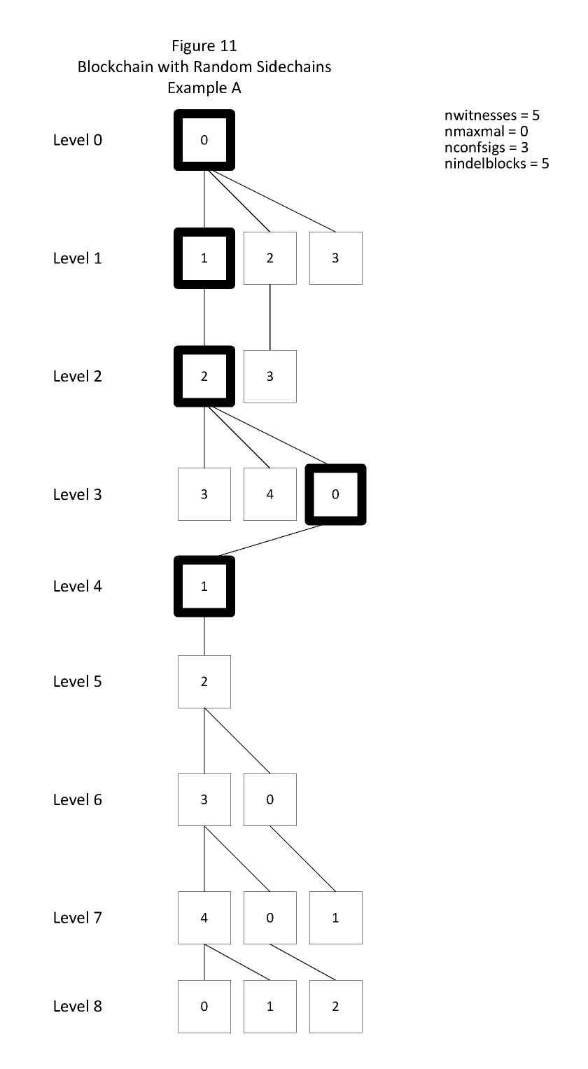

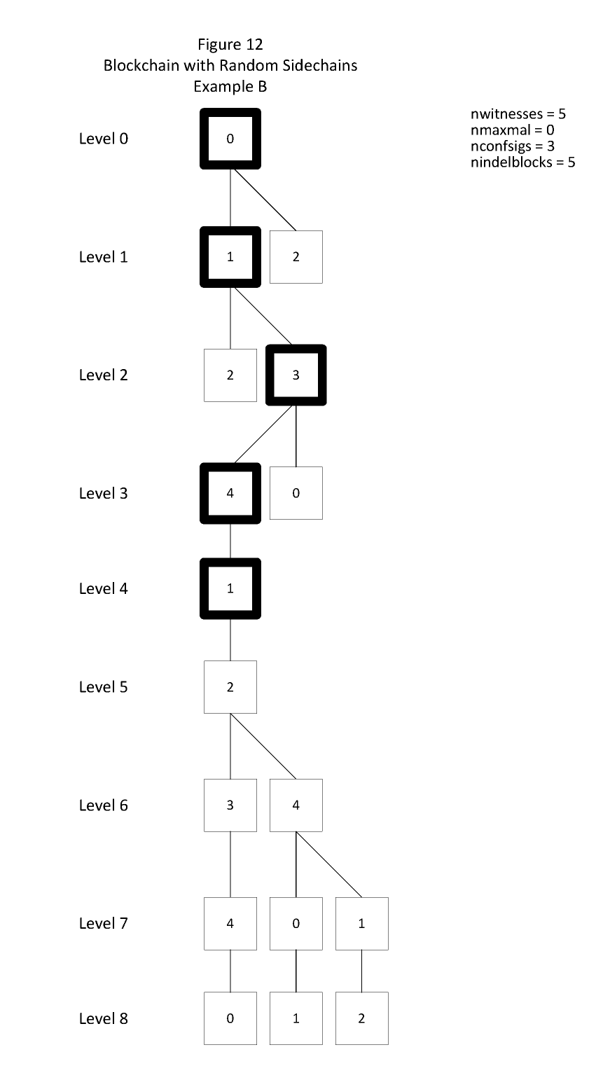

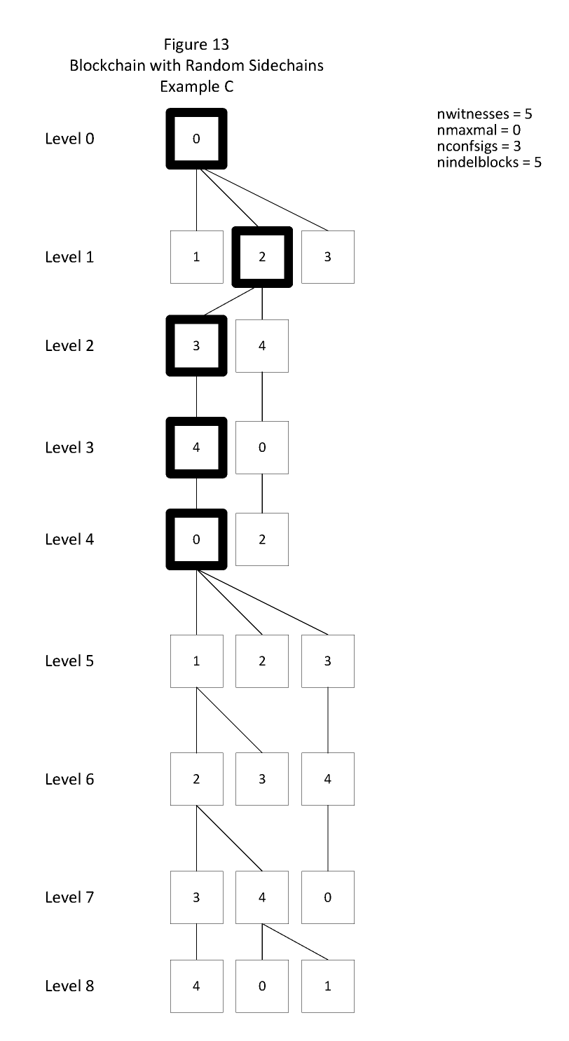

35. FIGS. 11 through 13 are examples of the witnesses building blocks at randomly-chosen allowed locations. FIG. 13 shows witness 1 building a block at the lowest score location at Level 1, and then building no more blocks for some time due to the Better Path rule. Ultimately though, when the alternate chain starting with the block by witness_2 at Level 1 becomes indelible due to the block built by witness_2 at Level 5, witness 1 is then able to build a block at Level 5. This shows how the Better Path Rule only applies to blocks that chain back to the most recently indelible block, and once the block by witness 1 at Level 1 no longer chains back to the most recently indelible block by witness_2 at Level 1, the Better Path Rule no longer applies to the block by witness 1 at Level 1.

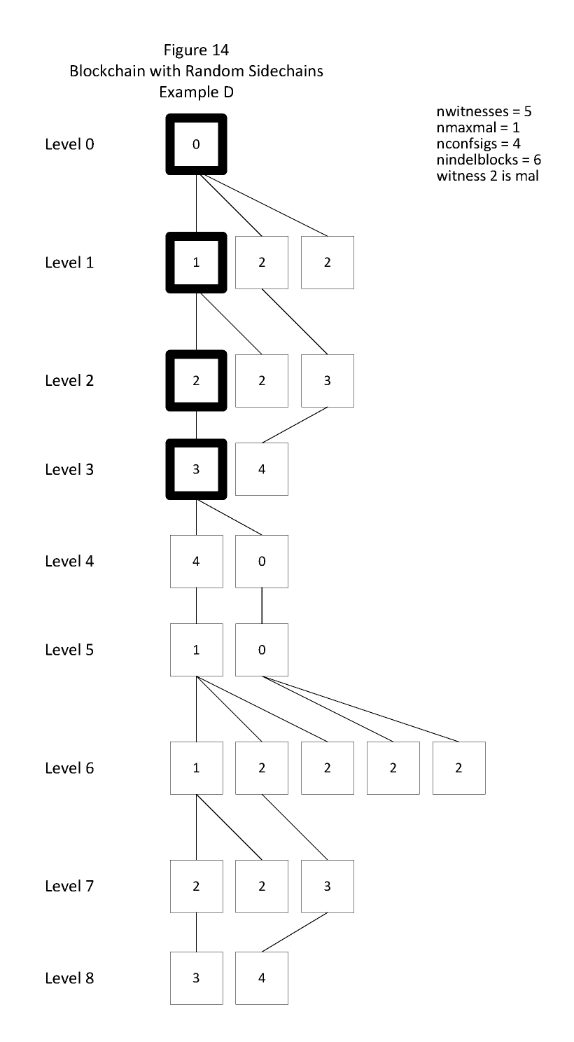

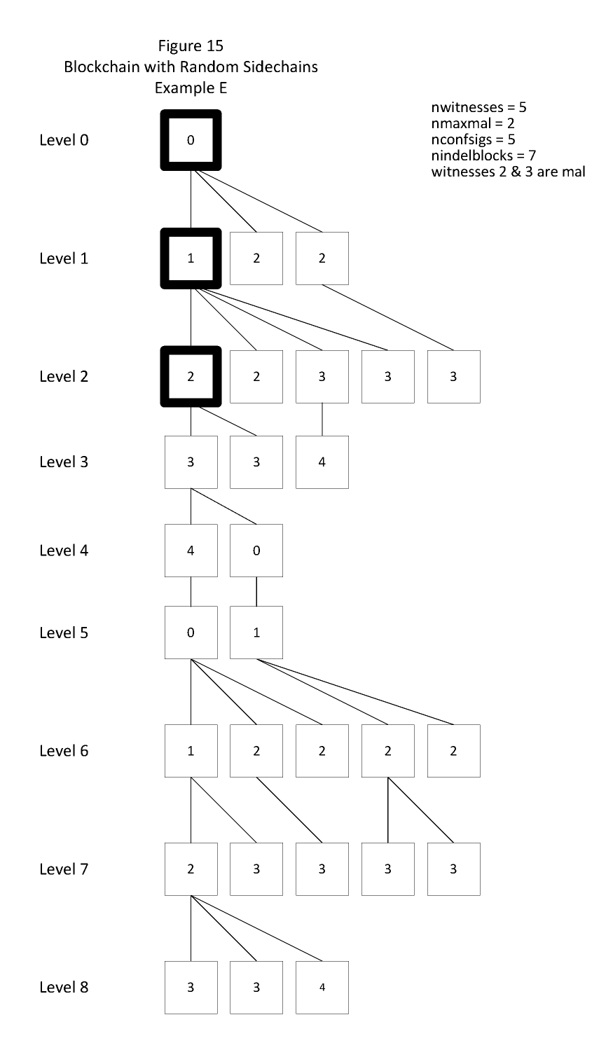

36. FIG. 14 shows how a blockchain might look when one witness, witness_2, is acting as a mal witness and not following the block assembly rules. Witness 2 has built two blocks at Level 1, in direct violation of the Increasing Level Rule. FIG. 15 shows how a blockchain might look when two witnesses, witnesses 2 and 3, are acting mal.

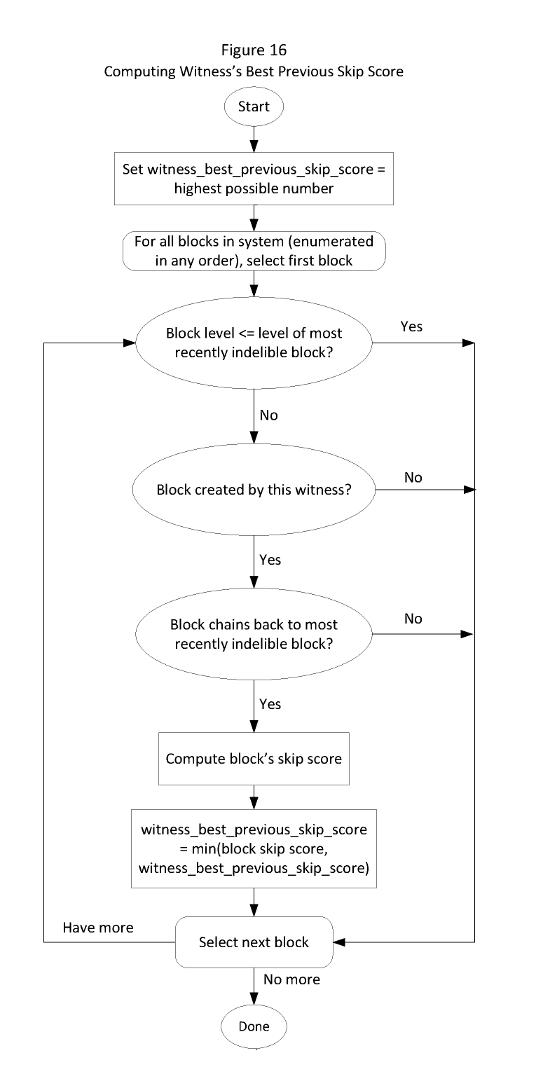

37. FIG. 16 is a flow diagram showing the computation of a witness's best previous skip score which is used in the application of the Better Path Rule. The first decision test, “Block level<=level of most recently indelible block?” follows from the “Block chains back to most recently indelible block?” test—if a block's level is less than the level of the most recently indelible block, it cannot chain back to the most recently indelible block. While it is not necessary to test the block level directly, doing so first allows the set of blocks to be rapidly pruned, and in fact, for the purpose of this computation, as witness does not need to keep track of any blocks at a level less than the most recently indelible block.

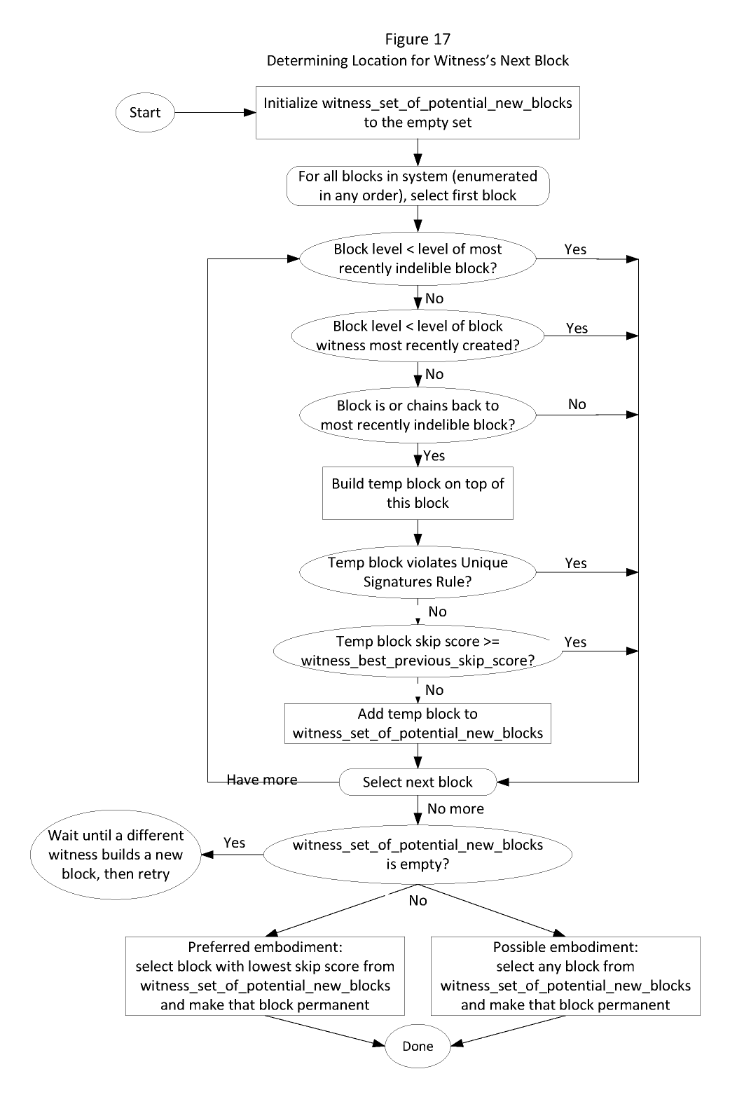

38. FIG. 17 is a flow diagram showing how a witness applies the block assembly rules to determine the locations it can build a block. The first test “Block level<level of most recently indelible block?” follows from the “Block is or chains back to most recently indelible block?” test and again allows the witness to rapidly prune the set of blocks it needs to test. The second test “Block level<level of block witness most recently created?” follows from the Increasing Level Rule, and the fifth test “Temp block skip score>=witness best_previous skip score?” is a restatement of the Better Path Rule.

The Transaction Protocol

The transaction protocol operates as follows:

1. The Payee generates a 256 bit random or pseudo-random master_secret. In most cases, this value would be used by the Payee for all transactions. For best security, the master_secret should be randomly generated or generated from a user passphrase using a strong key derivation function such as PBKDF2 with a cryptographically random 128 bit salt that is stored in a secure location.

2. The Payee computes:

root_secret=zkhash_A(master_secret)

where zkhash is a hash method designed to have all the properties of a cryptographic hash function (one-way, collision-free, pseudo-random) while capable of being efficiently verified in a zero knowledge proof. The details of the zkhash method are provided below.

3. The Payee chooses a 18 bit value for spend_secret_number and computes:

spend_secret=zkhash_B(root_secret,spend_secret_number)

In general, the Payee would start with spend_secret_number=0, and then increment destination_number each time it wanted a new spend_secret.

4. The Payee computes:

monitor_secret=zkhash_C(spend_secret)

5. The Payee computes:

receive_secret=zkhash_D(monitor_secret)

6. For each payment request, the Payee selects a 28 bit destination_number. In general, the Payee would start with destination_number=0, and then increment destination_number for each payment request.

7. The Payee selects an 8 bit value for locktime.

8. The Payee computes:

destination=zkhash_E(receive_secret,destination_number,locktime)

9. The Payee sends the destination to the Payor, preferably using a private communication channel such as a secure messaging application.

10. The Payor chooses the amount of the payment and locates one or more tokens that it can spend that have sufficient amounts in total to cover the payment.

11. The Payor queries the system to obtain the root hash of the Merkle tree containing all commitments in all indelible blocks in the blockchain.

12. For each input token, the Payor looks up the token's commitment_number (its location in the Merkle tree) and the hash inputs along the path from the commitment to the Merkle root. There is only one Merkle root input for the entire transaction, so the Merkle paths for all inputs tokens must be computed for the same tree state and lead to that single root value. If the commitment for the input token has not yet been added to the Merkle tree, the Payor sets the binary value no_serialnum=1 for this input and selects any value for commitment_number; otherwise, no_serialnum is set to 0. If none of the commitments for an input token is currently in the Merkle tree, the Payor looks up any recent valid value for the Merkle root and uses it to construct the transaction.

13. For each input token, the Payor computes

serial_number=zkhash_I(monitor_secret,commitment,commitment_number)

14. A transaction may contain multiple output tokens, each sent to the same or different destinations which might belong to the same or different payees. One of the output tokens would commonly be used by the Payor to return “change” back to itself

15. For each output token sent to a single destination, the Payor selects a 4 bit payment_number, and computes

address=zkhash_F(destination,payment_number)

amount_enc=amount̂zkhash_G(destination,payment_number)

commitment=zkhash_H(destination,payment_number,amount)

where ̂ is the bitwise exclusive-or operator.

16. The Payor selects an amount for witness_donation, a donation to the witnesses who incorporate this transaction into a block.

17. If necessary, the Payor adjusts the amount of “change” to itself in the transaction in order to satisfy the equation

sum(input token amounts)=sum(output token amounts)+witness donation

The change is included as a transaction output token, paid to a destination generated by the Payor.

18. During the zero knowledge proving system setup, a number of proving keys are generated for transactions with various capacities of input and output tokens. For example, proving keys are generated for transactions with one input and two output tokens, two inputs and two outputs, two inputs and four outputs, four inputs and two outputs, four inputs and four outputs, ten inputs and ten outputs, etc. The Payor selects a zero knowledge proof key that has sufficient capacity for the number input and output tokens in her transaction. Generally, the Payor would select the smallest possible key measured by the size of the key in bytes, in order to minimize the memory and CPU time needed to compute the zero knowledge proof

19. The Payor selects values for the binary quantities enforce_master_secrets, enforce_spend_secrets, outvals_public and nonfinancial. Their use will become apparent later in this specification.

20. The Payor constructs a zero knowledge proof using the Pinocchio system or an equivalent as follows:
Public inputs for the entire transaction:
   # of input tokens
   # of output tokens
   Merkle root
   witness_donation
   enforce_master_secrets
   enforce_spend_secrets
   commitments_published
   outvals_public
   nonfinancial
Public inputs for each input token:
   no_serialnum
   if commitments_published=1 or no_serialnum=1:
      the commitment
   if commitments_published=1 and no_serialnum=0:
      commitment_number
   if no_serialnum=0:
      serial_number
   locktime
Hidden inputs for each input token:
   if enforce_master_secrets=1:
      master_secret
      spend_secret_number
   if enforce_spend_secrets=1 or enforce_master_secrets=1:
      spend_secret
   monitor_secret
   destination_number
   payment_number
   amount
   the commitment
   if commitments_published=0 and no_serialnum=0:
      commitment_number
      the hash inputs along the tree path from commitment to Merkle root
Public inputs for each output token:
   address
   commitment
   if outvals_public=0:
      amount_enc
   if outvals_public=1, then for the first output token:
      amount_enc
   if outvals_public=1, then for the second and subsequent output token:
      amount
Hidden inputs for each output token:
   destination
   payment_number
   amount

The zero knowledge proof proves the following constraints are satisfied:
For the transaction as a whole:
   all public input values used to create the proof are the same as the public input values used to verify the proof

sum(input token amounts)=sum(output token amounts)+witness_donation
For each input token:
   if enforce_master_secrets=1:
      spend_secret=zkhash_B(root_secret, spend_secret_number)
      where root_secret=zkhash_A(master_secret)
   if enforce_spend_secrets=1:
      monitor_secret=zkhash_C(spend_secret)
   commitment=zkhash_H(destination, payment_number, amount)
      where:
      receive_secret=zkhash_D(monitor_secret)
      destination=zkhash_E(receive_secret, destination_number, locktime)
   if commitments_published=1 or no_serialnum=1:
      the commitment_published as a public input=the commitment used as a hidden input
   if commitments_published=1 and no_serialnum=0:
      the commitment_number published as a public input=the commitment_number used as a hidden input
   if commitments_published=0 and no_serialnum=0:
      the commitment, commitment_number and Merkle path hash to the Merkle root
   if no_serialnum=0:
      serial_number=zkhash_I(monitor_secret, commitment, commitment_number)
For each output token:
   address=zkhash_F(destination, payment_number)
   if outvals_public=0:
      amount_enc=amount ̂zkhash_G(destination, payment_number)
   if outvals_public=1, then for the first output token:
      amount_enc=amount ̂zkhash_G(destination, payment_number)
   if outvals_public=1, then for the second and subsequent output token:
      amount published as a public input=amount used as a hidden input
   commitment=zkhash_H(destination, payment_number, amount)

Constraints for input and output tokens that are allowed by the capacity of the proving key but not used in the transaction are not enforced, i.e., each constraint is multiplied by a conditional variable that reflects whether the input or output was used in the transaction.

21. The Payor constructs a transaction in which are published the public inputs to the zero knowledge proof, the id of the key used to construct the zero knowledge proof, and the zero knowledge proof itself.

22. The Payor broadcasts the transaction to the network. If the transaction has one or more inputs with no_serialnum=1, then the transaction must be grouped together with the prior transactions in which each such commitment appeared as an output, and the grouped transactions must be broadcast to the network as a bundle.

23. Every network node that receives the transaction checks that:
The witness_donation>=0.
The proof key id is valid.
The number of transaction inputs and outputs is sufficient for the capacity of the proving key.
The zero knowledge proof verifies using the public inputs published in the transaction.
The Merkle root published in the transaction is a valid value for the tree of all commitments.
Any commitments published for a transaction input token is a valid, unexpired commitment from the output token of a prior transaction, and if no_serialnum=0, then the commitment_number value for the input equals the commitment_number in the Merkle tree of that output token, or if no_serialnum=1, then the commitment appears in the output of a transaction that is bundled together with this transaction.
No serial_number published for a transaction input token has been used as a prior input for this transaction or an earlier transaction in a block that contains this transaction or any block prior to the extent the serial numbers in that block have not expired.

The expiration of commitments and serial numbers is discussed later in this specification.

If the transaction fails any of these tests, it is discarded. If it passes, the network node considers it to be valid. If the network node is a witness, the witnesses may place the transaction into a new block, as long as the transaction continues to be valid with respect to all prior transactions in the same block and all prior blocks. When assembling transactions into blocks, any transaction that has one or more inputs with no_serialnum=1 must be included in the same block as the transactions containing the output tokens with the same commitment values. The witness may then broadcast the new block across the network.

The effect of a valid transaction depends on the settings of enforce_master_secrets, enforce_spend_secrets, nonfinancial, and the locktime value of each input token. The following descriptions apply to cases in which nonfinancial=0. If enforce_master_secrets=0 and enforce_spend_secrets=0, then the input serial numbers or input commitments would be considered frozen, and could not be spent by any transaction except one for which enforce_master_secrets=1. If enforce_master_secrets=0, enforce_spend_secrets=1 and the locktime for any input token were non-zero, the transaction would be held and not acted on until a period of time passes, which could be related to the value of locktime, for example, locktime multiplied by 10 minutes. After the passage of that time, the transaction would be automatically processed as if locktime=0, or alternately, it could be resubmitted by the Payor, possibly with a reference to the prior transaction submission, at which time it would be acted upon immediately as if locktime=0. If enforce_master_secrets=1, or if enforce_spend_secrets=1 and the locktimes of all input tokens are zero and none of the serial numbers or commitments for the input tokens are considered frozen, the transaction would immediately be processed as a payment, with the input serial numbers entered into the list of spent serial numbers, and the output commitments added to the Merkle tree of valid commitments when the block containing the transaction becomes indelible, unless the commitment is published as a no_serialnum=1 input to another transaction in the same block.

In normal operation, a Payee would submit transactions with enforce_master_secrets=0 and enforce_spend_secrets=1. These transactions would transfer the input token amounts to the output tokens, possibly after a delay if any input token has a non-zero locktime. If the Payee has received a payment to a token that has a non-zero locktime, the Payee may monitor the blockchain for a transaction that contains that token's serial_number, and if a transaction is seen that was unauthorized or unintended, the Payee may submit a transaction with enforce_master_secrets=0 and enforce_spend_secrets=0 to freeze the token's serial_number. Later, the Payee may submit a transaction with enforce_master_secrets=1 to transfer the frozen token's value.

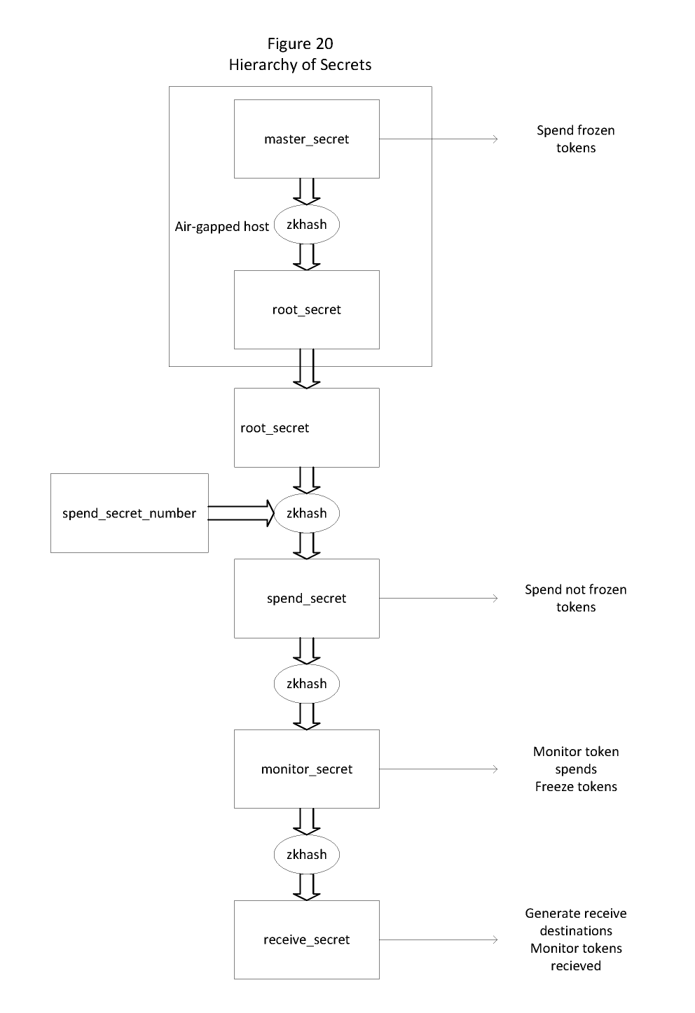

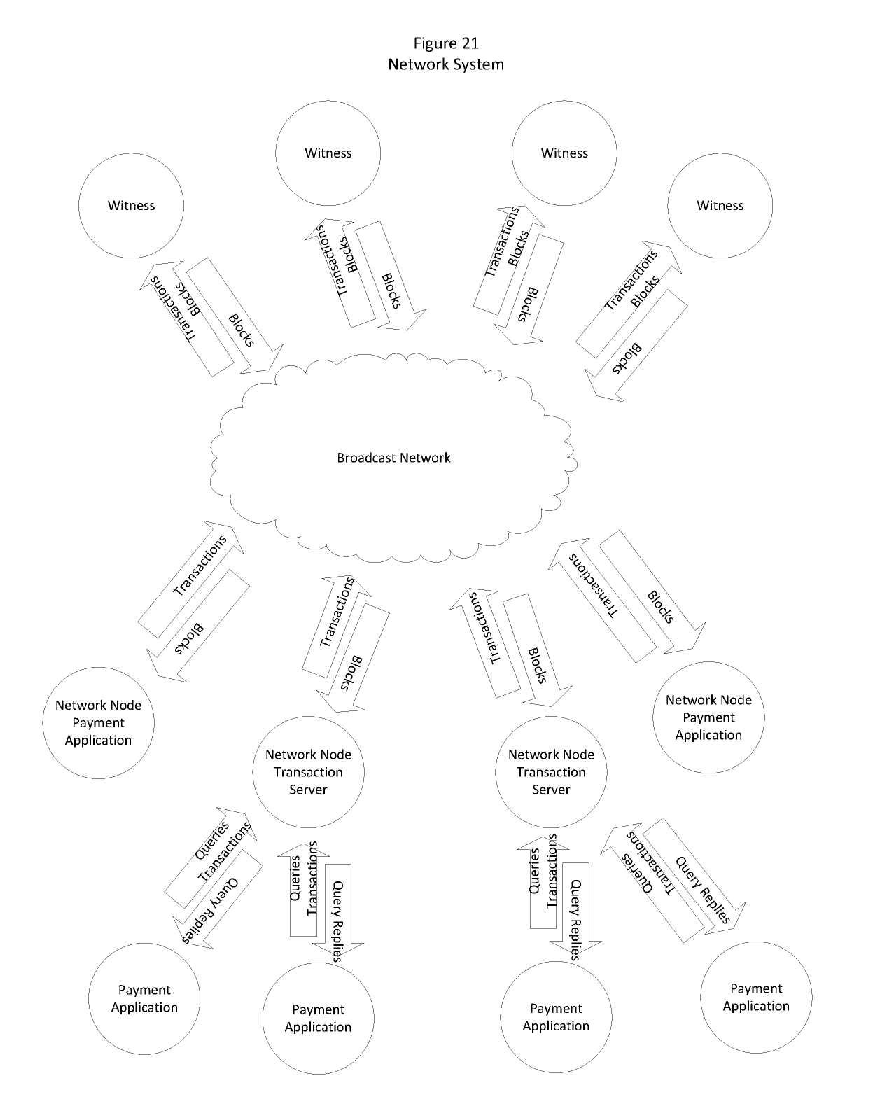

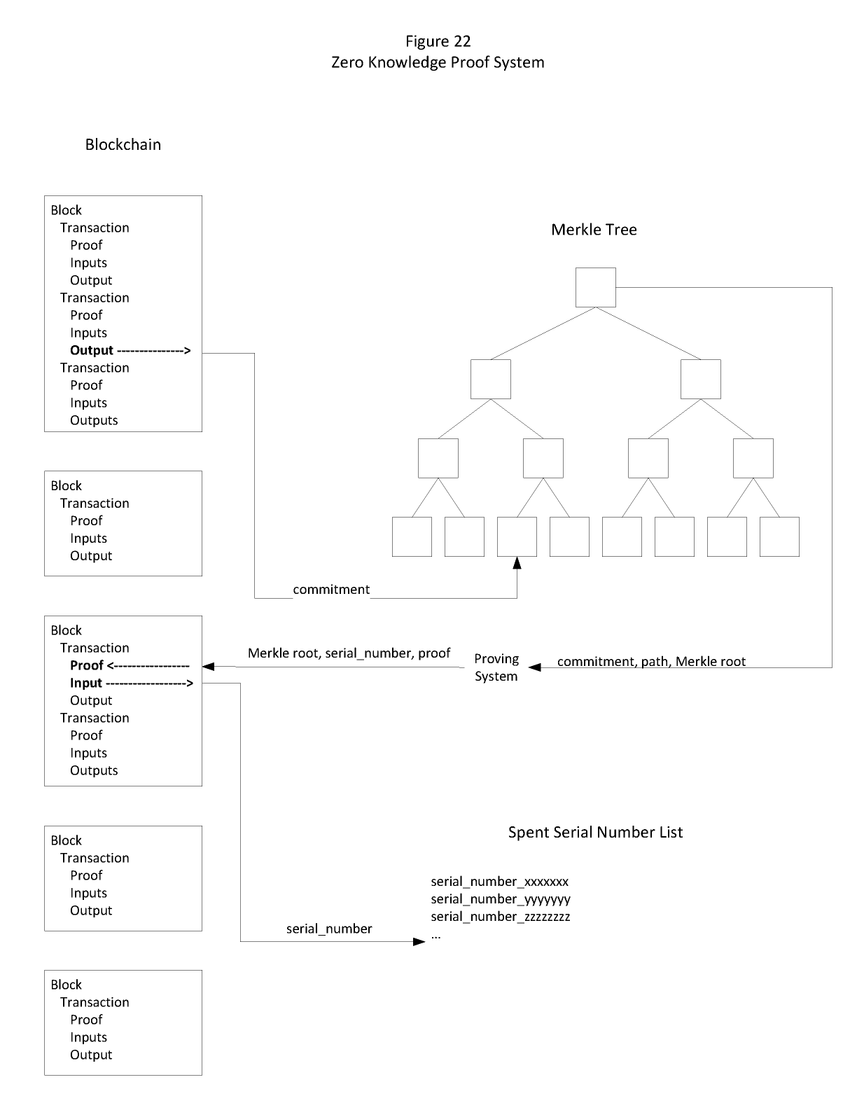

The secrets used in transactions follow a hierarchy from master_secret to root_secret to spend_secret to monitor_secret to receive_secret. This hierarchy allows the more privileged secrets to be more closely-protected. At the bottom of the hierarchy is the receive_secret. The receive_secret is used to generate destination values, and it can therefore be used to receive payments. Payment addresses which are published in the blockchain are computed from the destination, so the the receive_secret can also be used to monitor the blockchain for addresses corresponding to a destination, which indicates that a payment has been received. For an e-commerce website, a web server could be loaded with only the receive_secret, so that it could receive payments, but if the receive_secret were stolen from the server, it could not be used to spend the payments that were received. Next up on the hierarchy is the monitor_secret. The monitor_secret is used to generate the serial_numbers of tokens, and can therefore be used to monitor the blockchain for transactions that spend a token. Only the monitor_secret is required for transactions in which enforce_master_secrets=0 and enforce_spend_secrets=0, and therefore the monitor_secret may also be used to submit a transaction to freeze a timelock'ed token after an unauthorized or unintended transaction. Next up on the hierarchy is the spend_secret. The spend_secret can be used to create a transaction that spends a token that is not frozen, but cannot be used to spend a frozen token. The spend_secret can therefore be placed on a server that creates payment transactions, and if the spend_secret is stolen from that server and used to create unauthorized transactions, the tokens used in the transactions can be frozen with the monitor_secret and could then not be spent with the stolen spend_secret. The master_secret is required to spend tokens that have been frozen. The master_secret and root_secret can be generated on an air-gapped host, and only the root_secret transferred to a networked computer while the master_secret is securely stored offline and then used only when required to spend frozen tokens. FIG. 20 shows the hierarchy of secrets and the uses for each.

The use of spend_secret_number allows multiple spend_secrets to be generated from one master_secret. A Payee could use one spend_secret to generate a monitor_secret that it provides to an outside service to monitor transactions, while it generates a second spend_secret for transactions that it wishes to keep private from the outside service. Alternately, a Payee may generate and use a different spend_secret for every transaction. This would allow the Payee to provide the spend_secret to a third party to spend the token, or to generate a spend transaction on its behalf. These might be used if the token will be included in a transaction with other tokens from other parties, or it might be used if the Payee is using a mobile device that is unable to generate transactions on its own.

The system is designed so that commitments are only placed into the Merkle tree of all commitments after the block in which the commitment appears has become indelible, and then only if the commitment is not used in as a published input to another transaction in the same block with no_serialnum=1. This simplifies maintaining the Merkle tree since the blockchain protocol guarantees that the indelible block is permanent, and therefore the commitments it contains will not have to be removed from the Merkle tree, as would be the case if the block were not indelible and were superseded by another block.

The indelible block guarantee also simplifies the handling of spent serial_numbers. The spent serial_numbers from the indelible blocks can be placed into a single index of indelible spent serial_numbers. When searching to see if a serial_number has already been used, a node can scan the prior serial_numbers in the block that contains the transaction, and in prior blocks back to highest-level indelible block in the chain, and then check the index of indelible spent serial numbers.

Using the commitment_number to compute the serial_number ensures that all serial_numbers are unique (except got the very low probability of a collision in the zkhash output). This ensures that spending one valid token will not prevent a different valid token from being spent, which might occur if the two tokens had the same serial_numbers. An alternate construction would be to include the input serial_numbers in the computation of the output serial_numbers, instead of the commitment_number. This would have removed the need for the no_serialnum input, however, it would have required the Payee to track the input serial_numbers used in the transaction that created each token, which is an additional piece of information. Using only the commitment_number does not add an additional piece of information that must be tracked since the commitment_number is already needed to prove the Merkle path of the input token. One consequence of including the commitment_number in the computation of a token's serial_number is that the token is not assigned a serial_number until the block that contains the transaction becomes indelible and its commitment is added to the Merkle tree. Care must therefore be taken to ensure if a token is spent in a transaction with no_serialnum=1, its commitment does not get added to the Merkle tree. This is accomplished by ensuring that any transaction containing an input with no_serialnum=1 is bundled together with the transaction where the input token's commitment appears as an output, so the token spend can be detected before the token commitment is added to the Merkle tree.

When a transaction is included in an indelible block, it is said to have “cleared”. If the Payor wishes to check for the transaction to clear, it may check any one of the serial_numbers published in the transaction to see if it has been added to the list of indelible spent serial_numbers. If the Payee wishes to check if a payment has been made, it may compute the assumed payment_addresses and monitor the blockchain for transactions to those addresses. When such a payment is detected, the Payee may retrieve the amount or, depending on the value of outvals_public, the amount_enc and then compute the amount using the formula

amount=amount_enĉzkhash_G(destination,payment_number)

Anyone who knows the destination can similarly monitor the blockchain for a transaction and decode the amount. For that reason, payment destinations should only be sent privately and securely from the Payee to the Payor. For the highest level of privacy, a Payor should also never send more than one payment to the same address, since that publicly links the payments.

A transaction with outvals_public=1 can be used by a Payor who wishes to publicly publish the token output amounts in the blockchain. The first output token amount is still encrypted however, which the Payor can use for the transaction “change”, allowing the total amount of the input tokens and the change amount to be kept private while the amounts of the second and subsequent output tokens are publicly published.

Transactions with nonfinancial=1 can be used for alternate applications such as voting. For example, if it is desired to allow each token holder to vote in proportion to the total amounts of the tokens they control, a copy can be made of the blockchain at a single moment in time, and the copy used to record votes. Each token holder would create transactions to send their tokens to destinations that correspond to their votes, for example, destination=0 could be used for a vote of “Yes” and destination=1 could be used for a vote of “No”. These transactions could be created with nonfinancial=1 to ensure they would not be accepted into the main blockchain, but they would be accepted into the blockchain that records votes. In addition, only transactions with outvals_public=1, could be used so that the amount of each vote was public. In that case, the voter would set the transaction “change” amount in the first transaction output token to zero in order to vote the full amount of the transaction input tokens. Alternately, the output amounts could be encrypted in the voters' transactions, and then at the conclusion of voting, the total amount sent to each destination revealed by creating transactions to transfer the amount sent to each vote destination to a final tally destination with outvals_public=1.

Transaction Protocol Design Rationale

Because the commitment is published in the blockchain and included in the Merkle tree, no one can spend a non-existent output token or change the commitment, the output amount, or the master_secret, spend_secret or monitor_secret without finding a hash collision. Because the master_secret, spend_secret or monitor_secret are included in the zero knowledge proof, no one can spend the output unless they know the secret, can either find a hash collision or reverse the hash function, or find a “collision” in the 288 byte zero knowledge proof. Because the serial_number is published in the transaction and checked for a prior spend, no one can spend an output twice without finding a hash collision. In short, since it is extremely unlikely if not impossible to find a collision or reverse the hash function, the zero knowledge proof ensures the integrity of the system while keeping the transaction information private.

One potential attack is to attempt to create two tokens with different amounts but the same commitment, then enter the lower amount token into the blockchain and spend the higher amount token. This would require finding a hash collision, i.e., two sets of inputs that hash to the same commitment. While that itself is extremely unlikely, the commitment iv, which comes from the value of a recent Merkle root, was added to the commitment's hash inputs to limit an attacker's ability to exploit a collision if one were found.

Along with verifying the zero knowledge proof, every node on the network also verifies that the serial_number published in the transaction has not already been spent in an earlier transaction in the blockchain. This prevents a payment from being spent twice. The serial_number cannot however be publicly connected to the commitment_published when the payment is made because the two are not published together in the same transaction (as long as the commitment's Merkle path is provided only as a hidden input to the subsequent transaction), and the only information that ties them together, the amount and monitor_secret, are kept private by the zero knowledge proof and never published.

It was desired that a user should be able to detect and gather sufficient information to spend incoming payments only by monitoring the blockchain, and for that reason, an address that can be computed by the Payee and the output amount (required to spend the payment) in encrypted or unencrypted form were added to the blockchain. This formulation also allows an application to recover their contents from a single master_secret if all of the addresses are generated in a predicable way. This allows the blockchain to serve as a continuous backup of a participant's tokens to help prevent loss.

It would also have been possible for the Payee to provide a persistent ECDH (elliptic curve Diffie-Hellman) key along with a payment destination, for the Payor to add a session ECDH key to the transaction, and for the transaction address and amount to be encrypted using the shared ECDH secret. However, this formulation would have required the Payee to monitor and attempt to decrypt every transaction in the blockchain to see which payments were sent to it, and was therefore deemed impractical for most Payees.

The “Zkhash” Method

A zkhash is computed as follows:

1. First, each input is decomposed into binary bits, and then the bits of all inputs are concatenated into one long array of n bits, which will be called b[1], . . . , b[n]

2. From the input bits, two pseudo-independent knapsack or “subset sum” values kx and ky are computed:

kx=b[1]*x1+b[2]*x2+ . . . +b[n]*xn

ky=b[1]*y1+b[2]*y2+ . . . +b[n]*yn

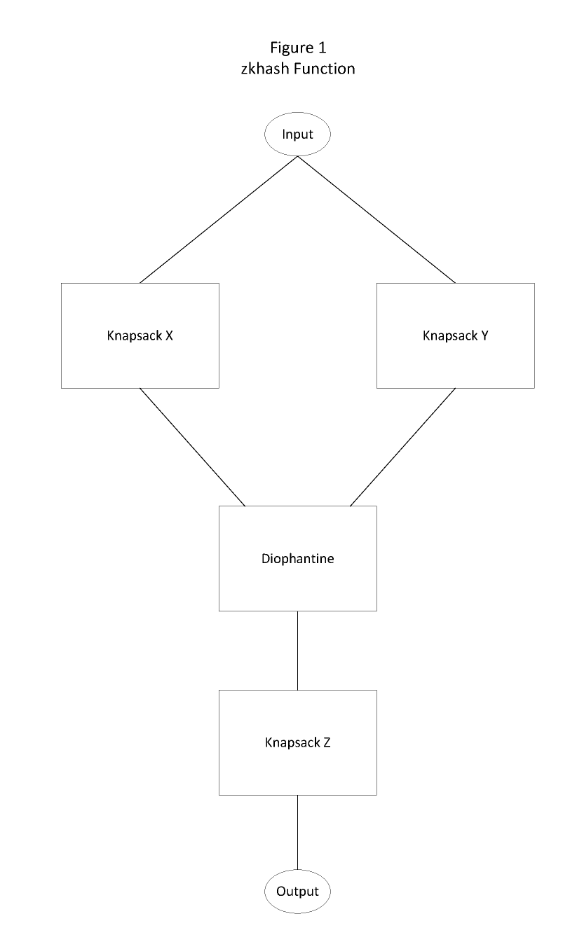

Each of the coefficients xi and yi are 254-bit values in the prime field P, and the arithmetic operations in all steps are computed modulo the prime P. In FIG. 1 shows the array of bits b[1], . . . , b[n] labelled “Input”, kx labelled “Knapsack X” and ky labelled “Knapsack Y”.

3. A Diophantine polynomial d of degree 256 is computed in the prime field from the pseudo-independent knapsack values as follows:

d = kx + ky
for (i = 1; i <= 8; ++i)
{

kx = kx*kx + kx + 1
ky = ky*ky − ky + 1

}
d = d + kx + ky

Theses arithmetic operations are performed modulo the prime P.

4. The sum d above is decomposed into the number of bits needed for the hash output, i.e., if h bits are needed for the hash output, d is decomposed into bits d[1], . . . , d[h] with the remainder r. Generally, all 254 bits of the prime field are desired in the final output, but in certain situations (such as the computation of amount_enc), only a smaller number of bits such as 64 are needed.

5. A third knapsack value kz is computed in the prime field from the bits of d, as follows:

kz=d[1]*z1+d[2]*z2+ . . . +d[h]*zh

6. The zkhash output is the value of the final knapsnack kz. In situations where fewer bits than the full field are desired, the value kz is decomposed into the desired number of bits plus a remainder, and the remainder disregarded.

7. For each instantiation of the zkhash method, zkhash_A, . . . , zkhash_I, a different set of constants x[1], . . . , x[n], y[1], . . . , y[n], z[1], . . . , z[h] are used. These constants can be randomly generated, or pseudo-randomly generated from a hash function such as

ci=SHA256(“<constant name><constant number><j>”)

where j is the smallest integer that gives a ci less than the prime P.

The Commitment Merkle Tree

Participants in the protocol maintain a Merkle tree of all commitments which is used to prove a commitment exists without revealing the specific commitment. Commitments are entered into the Merkle tree from left to right in the same order they appear in the blockchain. Commitments are assigned consecutive commitment numbers, with the first commitment placed in the tree assigned commitment_number=0, the next commitment_number=1, etc.

At the tree leaves, the commitments are first hashed with the commitment_number:

leaf_hash=zkhash_J(commitment,commitment_number)

This makes it difficult for an attacker to predict the leaf_hash input, which makes potential “chosen hash” attacks more difficult.

In the Merkle tree, a slightly modified version of zkhash is used as a compression function. It takes two 254 bit inputs and computes a single 254 bit output. When computing the inner hashes, instead of forming one long bit string from the two inputs, the bits from each input are instead multiplied by the same coefficients and then added together, i.e., if the two inputs are a and b, the initial knapsacks kx′ and ky′ are computed by:

kx′=kx(a)+ky(b)=(a[1]*x1+ . . . +a[n]*xn)+(b[1]*x1+ . . . +b[n]*xn)

ky′=ky(a)+ky(b)=(a[1]*y1+ . . . +a[n]*yn)+(b[1]*y1+ . . . +b[n]*yn)

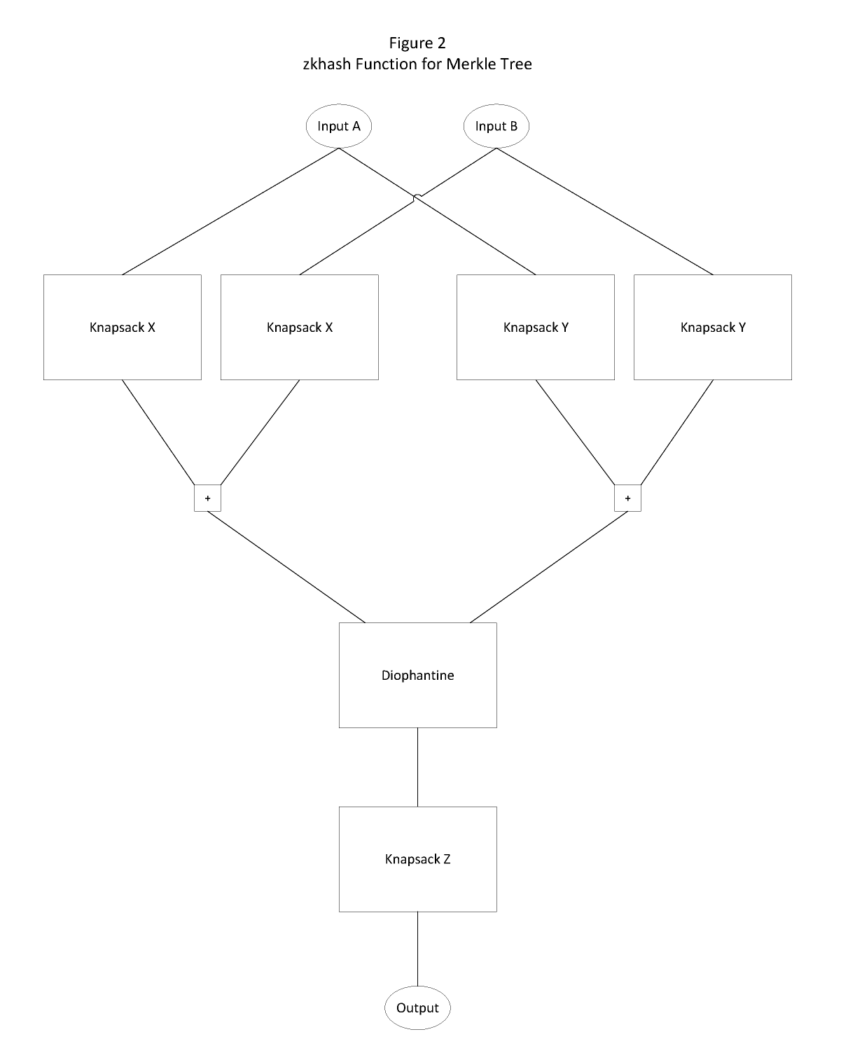

and then the Diophantine is computed using kx′ and ky′. This makes the resulting hash independent of the order of the inputs a and b which simplifies the constraint system needed in the zero knowledge proof to verify a Merkle path. FIG. 2 shows the commutative formulation used to compute the Merkle tree hashes, with the array of bits a[1], . . . , a[n] labelled “Input A”, the array of bits b[1], . . . , b[n] labelled “Input B”, the multiplication by the coefficients x1, . . . , xn and summation labelled “Knapsack X”, the multiplication by the coefficients y1, . . . , yn and summation labelled “Knapsack Y”, and the sums kx′ and ky′ represented by the output of the (+) operation.

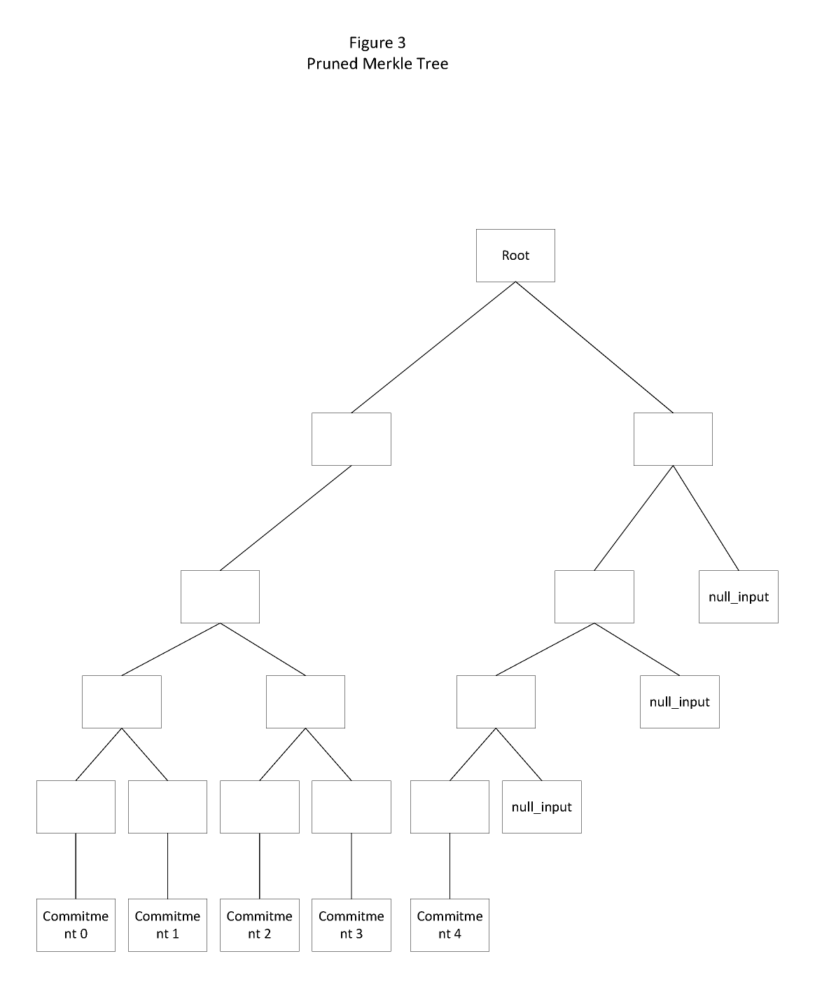

The Merkle tree structure is pruned, meaning no hash value is computed for positions in the tree for which no commitments exist in both the left and right input paths. When a hash is computed that has commitments in the path of only one of its two inputs, a null_input is used on the side with no commitments. The null_input is changed each time commitments are added to the tree by setting it equal to the lower 256 bits of the blake2b hash of the block that contains the commitments being added, modulo the prime P. This adds an element of randomization to the Merkle root and makes attacks that might seek to create a collision in the Merkle root more difficult. FIG. 3 shows an example Merkle tree with a capacity of 2̂4=16 commitments. The leaf entries (shown at the bottom), contain the commitment values hashed with their corresponding commitment numbers (not shown). The tree shown contains nine commitments, and the null_input is used in three places where the hash would otherwise only have a single input.

zkhash Design Rationale

The zkhash uses only multiplications, additions and subtractions performed in the prime field P, which are the same basic operations supported by the Pinocchio zero knowledge proving system. This allows it to be efficiently implemented using a minimum number of operations.

The first two knapsacks are each used as a compression/expansion function and a pre-pseudo-randomizer. It compresses or expands the input bits to 254 bits, and spreads the input entropy uniformly through those 254 bits. According to Ben-Sasson, et al. (https://eprint.iacr.org/2014/595) and the references cited therein, a single knapsnack (which recent versions of the paper call a “subset sum” function) in a prime field is cryptographically secure. However, it has a relatively simple structure. Due to the simplicity, it would seem imprudent to rely only on a single knapsack. It does however do a very good job of spreading the input entropy out across the accumulator, which greatly enhances the cascade effect of any subsequent stages. For that reason, it makes a very good pre-pseudo-randomizer.

The second stage is a Diophantine polynomial of degree 256 with two semi-independent inputs. Diophantine equations have been extensively studied for many years, and arbitrary high-degree bivariate Diophantine equations are considered to be unsolvable. A Diophantine in the prime field P should be even more difficult to solve. Each time the 254 bit input is squared, it potentially aliases around the prime 2̂254 times. This makes enumerating the aliases at least as difficult as enumerating the output values. The coefficients and degree of the Diophantine were derived from simulations using smaller 8 to 16 bit inputs in a scaled prime field (P˜=0.756*2̂nbits), and those parameters were found by themselves, without any input conditioning, to produce a pseudo-random output close in quality to a good pseudo-random function.

The last knapsack ensures the output appears completely random, and makes it that much more difficult to recover the inputs from the output. It may not be necessary but the cost is manageable and it seems prudent to include.

Expiring Commitments and Serial Numbers

The Merkle tree is binary with a height of 40 and can hold up to 2̂40 commitments. To keep the size of the Merkle tree and the spent serial number list from growing without bound, commitments and serial numbers expire after some amount of time, for example after 5 years, and are then removed from the Merkle tree and spent serial number list. Alternately, they could expire after the Merkle tree reaches a certain threshold of its capacity, for example, when it is 95% full. After a commitment expires, the token would be unspendable by using a transaction described above. To prevent this, the holder of the expiring token can roll the token amount over into new token by creating and submitting a transaction that sends the token amount one of the holder's own destinations.

Serial numbers would not be removed from the spent serial number list until it is certain from the passage of time that the corresponding commitment has been removed from the Merkle tree, which ensures that the token would no longer be spendable using one transactions described above and therefore could not be spent twice. Serial numbers would be removed by scanning blocks that became indelible before the expiration time, and removing all serial numbers found in those blocks from the spent list.

Alternately, or in addition, an expired token could be spent with a special transaction type. This transaction would be identical to the transactions discussed above, but would be marked “spend_expired”. It would have commitments_published=1 and no_serialnum=0 for each input. The Payor would also have to publish with each input token the level of the block containing the transaction T that has the commitment value in an output token O.

Each network node that wishes to check the validity of this transaction would need to retrieve the identified block and confirm that it contains transaction T with output O. It would then have to confirm that the commitment_number assigned to output O matches the commitment_number used in the spend transaction. To facilitate this, the network node could store with each block the commitment_number that corresponds to the first output of the first transaction in the block, and then compute the commitment_number for output O by counting the number of transaction outputs that appear between the first transaction output and output O.

The network node would also need to verify that the token's serial_number never appeared as the input to a prior transaction. To accomplish this, the serial_number the same block, prior blocks and in the indelible spent serial number list would be checked for the serial number, just like a normal transaction. In addition, as blocks are scanned to expire serial numbers, the expiring serial numbers would be added to a Bloom filter. This would continue until half of the bits in the Bloom filter were set, at which point a new Bloom filter would be started and filled. To confirm a serial number had never before appeared in the block chain, a node would also check all Bloom filters. If the Bloom filter signaled a potential match, all of the blocks that contributed serial numbers to the Bloom filter would be scanned to look for the serial number, and if it were found, the transaction would be rejected. If no Bloom filter signaled a potential match, or if the serial number were not found after scanning all blocks in which a Bloom filter signaled a potential match, then the transaction would be allowed, subject to the other required conditions (witness_donation>=0, zero knowledge proof and key id valid and has sufficient capacity). An accepted transaction would be added to a block and processed just like a normal transaction, with the output commitments added to the Merkle tree when the containing block becomes indelible, and input serial_numbers added to the list of indelible spent serial numbers.

Transaction Server

In order to create a transaction, a Merkle tree of all commitments must be maintained in order to compute the path from a transaction input token's commitment to the Merkle root. Even with the expiration of commitments, this is expected to be a larger data structure than many user applications will want to maintain. In order to allow lightweight applications to create transactions, a transaction server may be provided to obtain the necessary information. When an application wishes create a transaction, it first contacts a transaction server and requests the Merkle paths from one or more input token commitments to the Merkle root. If the application trusts the transaction server to keep its requests private (for example, if the transaction server is run by the user itself, or by a trusted party), the information returned by the transaction server can immediately be used to construct a transaction.

If the application does not trust the transaction server, maintaining complete privacy requires a little more work. In that case, the application cannot simply construct a transaction using the Merkle root returned by the transaction server because the server might correlate the Merkle root it provided with the Merkle root published in the transaction, thereby linking the transaction inputs and outputs and partially compromising privacy. To maintain complete privacy, an application may request the Merkle path for each commitment one at a time, possibly from different transaction servers and/or at different times in advance of their use.

When ready to spend the outputs, the application would query the transaction server to obtain only the portion of the paths that have changed since the earlier queries. The Merkle path for each commitment consists of a list of hash inputs from the commitment's leaf position down to the root. As commitments are added to and expired from the tree, only the hashes at the “edges” and root part of the tree would change, while the hashes at the center would remain the same. When the application is ready to spend the commitments, it requests the transaction server provide the location of the edges where the tree was last updated. For each commitment the application wishes to spend, the application computes which values in the commitments' Merkle paths have changed, and then requests only the changed values from the transaction server. Along with these values, it would again receive the location of the edges where the tree was last updated, and from this, it would recompute which values in the commitments' Merkle paths had changed, and if additional locations had changed, it would repeat the query until no additional locations had changes. The application would then update the Merkle path for each commitment based on the changed entries, and then construct a spend transaction with the updated paths. Since the changed path inputs would be toward the root of the tree and span many commitments, the transaction server would be unable to identify the specific commitments the application is updating.

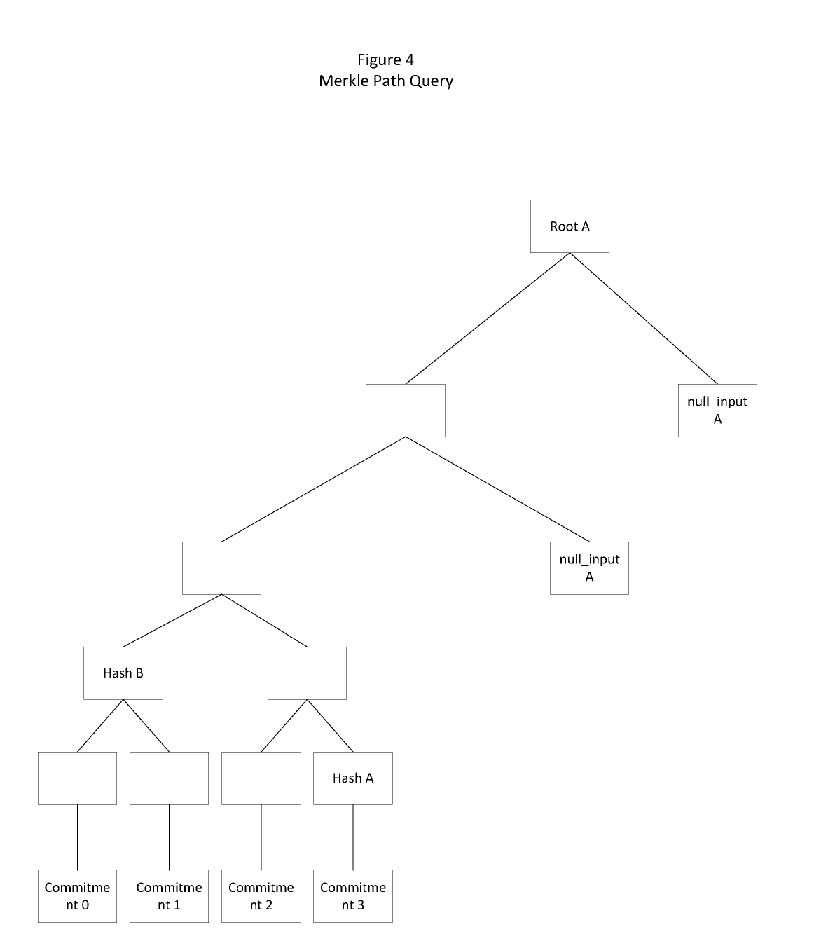

In FIG. 4, shows a Merkle tree with four commitments. When an application requests the Merkle path for Commitment 2, the server returns Hash A, Hash B, null_input A, null_input A and Root A. These values are used as hidden inputs to a zero knowledge proof to prove that the application knows Commitment 2 which hashes to Root A with the computation:
h0=zkhash_J(Commitment 2, 2)
h1=zkhash_K(h0, Hash A)
h2=zkhash_K(h1, Hash B)
h3=zkhash_K(h2, null_input A)
Root A=zkhash_K(h3, null_input A)

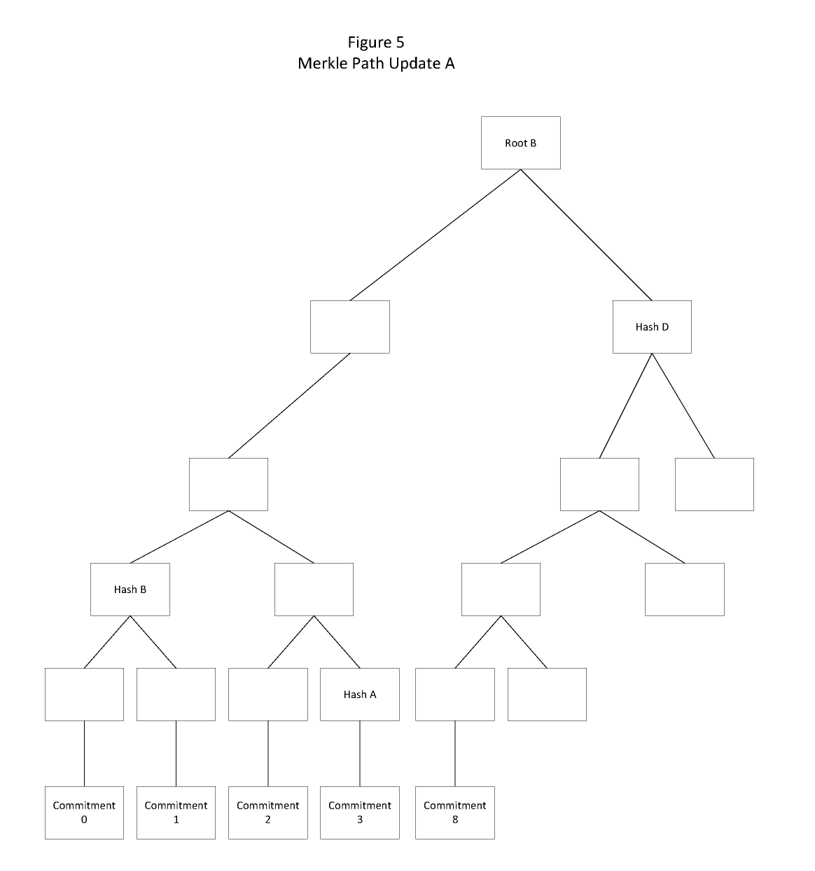

Later, as shown in FIG. 5, the application might query the server and discover there are now nine commitments in the Merkle tree. The application can compute from this that since the number of commitments in the tree changed from four to nine, in order to update the path it previously retrieved for Commitment 2, the application requires Hash C, Hash D and Root B. The application then queries the server to obtain these values. If the application wanted to spend Commitment 2 at this point, it could input into a zero knowledge proof Commitment 2, 2, Hash A, Hash B, Hash C and Hash D to prove it knows Commitment 2 which hashes to Root B with the computation:
h0=zkhash_J(Commitment 2, 2)
h1=zkhash_K(h0, Hash A)
h2=zkhash_K(h1, Hash B)
h3=zkhash_K(h2, Hash C)
Root B=zkhash_K(h3, Hash D)

The server observed, among all the requests from all applications that are communicating with it, a request to obtain the path for Commitment 2, a request to obtain Hash C, Hash D and Root B, and a transaction in which Root B is published. The server can easily correlate the transaction with the request for Hash C, Hash D and Root B, and from this, it can infer that an application was updating some commitment in the range of 0 and 3, but it cannot tell which. Because the request to obtain the path for Commitment 2 came earlier and the response did not contain Root B, the server is unable to correlate the transaction with Commitment 2.

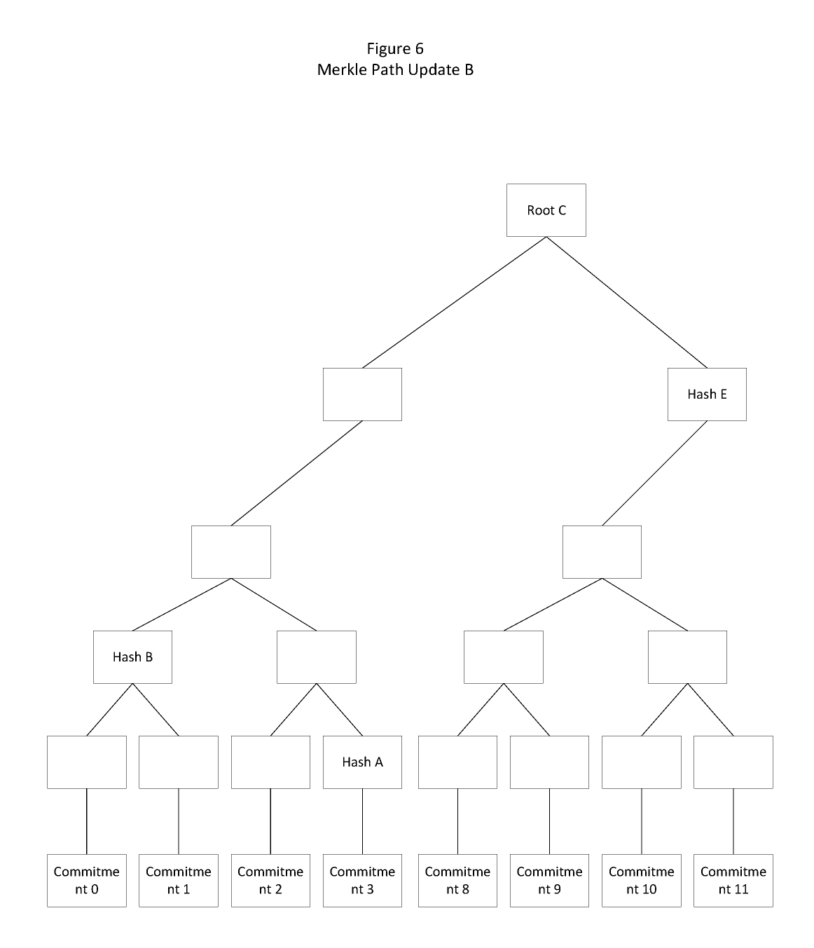

Alternately, instead of spending Commitment 2 immediately after the second query, the application waits a period of time, then queries the server again and discovers there are now twelve commitments in the Merkle tree, as shown in FIG. 6. The application can compute from this that since the number of commitments in the tree changed from nine to twelve, in order to update the path again, it now requires Hash E and Root C. The application queries the server to obtain these values, and then inputs into the zero knowledge proof Commitment 2, 2, Hash A, Hash B, Hash C and Hash E to prove it knows Commitment 2 which hashes to Root C with the computation:
h0=zkhash_J(Commitment 2, 2)
h1=zkhash_K(h0, Hash A)
h2=zkhash_K(h1, Hash B)
h3=zkhash_K(h2, Hash C)
Root C=zkhash_K(h3, Hash E)

In this case, the server observed, among all the requests from all applications that are communicating with it, a request to obtain the path for Commitment 2, a request to obtain Hash C, Hash D and Root B, a request to obtain Hash E and Root C, and a transaction in which Root C is published. The server can easily correlate the transaction with the request for Hash E and Root C, and from this, it can infer that an application was updating some commitment in the range of 0 and 7, a larger range than the previous example.

The application is not limited to making only three requests to update a path; it can attempt to time its requests to obtain each intermediary hash value after enough commitments have been added to the tree that the intermediary value becomes unlikely to change again. By making multiple requests separated in time, the application makes it more difficult for the server to correlate the Merkle root value published in a transaction with the commitment or range of commitments used as inputs to the transaction. In general, three requests should be sufficient to obtain a very high level of privacy from the transaction server, as long as the penultimate request comes some time before the transaction. Depending on the total number of requests the transaction server receives each day from different applications, a penultimate request 24 hours before the transaction, with some randomly added time variance, should be sufficient.

When commitments begin to expire and are removed from the Merkle tree (after 5 to 10 years), they would be removed from the left side of the tree. The application can similarly query the server to obtain the former location of the commitment that was most recently removed from the tree, and use that information to determine which inputs it needs to obtain on the left edge of the tree to update the paths for its commitments. In this case however, the edge where commitments are removed would move closer to the locations of the commitments being spent, rather than further way. This would increase the number of changed values in the Merkle paths and would reduce the privacy of the query. If desired to maintain privacy, the application could spend or rollover the tokens before the update edge got too close to the locations of their commitments.

What is claimed is:

1. A system for generating blockchains comprising: a set of witnesses that assemble and digitally sign one or more blocks, in which a witness may be added or removed from the set of witnesses by inserting a control message into a block, and in which the addition or removal of said witness becomes effective for all blocks that link back to said block.

2. A system for generating blockchains comprising: a set of witnesses that assemble and digitally sign one or more blocks; a protocol that ensures that blocks that meet specified criteria are indelible, in which a witness assembles a first block and then generates a first private signing key with a corresponding public verification key, and includes said public verification key with said block, and signs said block with a second private signing key, and in which any immediate successor second block to said first block is signed using said first private signing key, and in which said second private signing key is erased from the memory of said witness if said second block becomes indelible.

3. A system for generating blockchains comprising: a set of witnesses that assemble and digitally sign one or more blocks; a protocol that ensures that blocks that meet specified criteria are indelible, in which if any participant has received a first block at a blockchain level that meets the criteria to be indelible, and then receives a different second block also at said blockchain level that also meets the criteria to be indelible, said participant rejects said second block and immediately stops accepting or processing blocks.

4. A method for tracking tokens comprising: assigning a token a timelock value; accompanying a first message to transfer or assign said token with a proof that a sender knows a first secret value; holding said first message and not acting on said first message until the time period indicated by said timelock value, if any, has passed; transmitting or broadcasting said first message such that it may be monitored by the public or by a participant knowing a second secret value which may be the same as said first secret value; transmitting or broadcasting a second secret message accompanied by a proof that the participant knows said second secret value, prior to said first message being acted on, where said second message causes said token to freeze and not be acted upon by said first message or any other message to transfer or assign said token except one that is accompanied by proof that the sender knows a third secret value which is not the same as either the first secret value or the second secret value; in the absence of said second message, acting upon said first message after the passage of time indicated by said timelock value, if any, or in the alternative, when said first message is resent after the passage of the time indicated by said timelock value.

5. The method of claim 4, further comprising: requiring only a fourth value to create or receive tokens, where said fourth value is derived from said third secret value using a one-way function, and where said third secret value and said fourth value may be generated on a computer system that is not connected to any network, and where only said fourth value is transferred or copied to a computer system used to create or receive tokens, while said third secret value is not stored on a computer system connected to any network, but may be used on a computer system connected to a network when needed to transfer or assign a frozen token.

6. The method of claim 5, where said one-way function is a cryptographic hash function.

7. The method of claim 5, where said one-way function is a digital signing function in which said third secret value relates to a secret signing key and said fourth value relates to a signature verification key.

8. A method of computing a cryptographic hash comprising: using a polynomial function to compute a cryptographic hash.

9. The method of claim 8 further comprising: using said cryptographic hash to compute a zero knowledge proof.

10. The method of claim 8 where an input to said polynomial function is an output of a subset sum function.

11. The method of claim 10 further comprising: using said cryptographic hash to compute a zero knowledge proof.

12. The method of claim 8 further where said polynomial function is a Diophantine polynomial with two or more pseudo-independent inputs.

13. The method of claim 12 further comprising: using said cryptographic hash to compute a zero knowledge proof.

14. The method of claim 12 where the inputs to said Diophantine polynomial are the outputs of subset sum functions that have independent coefficients.

15. The method of claim 14 further comprising: using said cryptographic hash to compute a zero knowledge proof.

16. The method of claim 14 where the input to all subset sum functions is the bitwise sum of the cryptographic hash inputs.

17. The method of claim 16 further comprising: using said cryptographic hash to compute a Merkle tree.

18. The method of claim 17 further comprising: using said Merkle tree to compute a zero knowledge proof.

19. The method of claim 12 where said pseudo-independent inputs are first used in a commutative operation.

20. The method of claim 12 further comprising: using said cryptographic hash to compute a Merkle tree.

21. The method of claim 20 further comprising: using said Merkle tree to compute a zero knowledge proof.

22. The method of claim 8 where said cryptographic hash has two or more inputs that are first used in a commutative operation.

23. The method of claim 22 further comprising: using said cryptographic hash to compute a Merkle tree hash.

24. The method of claim 23 further comprising: using said Merkle tree hash to compute a zero knowledge proof.

25. A token tracking system comprising: a generator which generates token identifiers such as commitments; a Merkle tree which contains token identifiers; a token proof module in which a zero knowledge proof is used by a token holder to prove the identifier is a member of a set of identifiers in said Merkle tree when a token is used as a subject of a subsequent action; and a token expiration module in which token identifiers expire and are removed from said Merkle tree when specified expiration criteria are met.

26. The system of claim 25, in which said expiration criteria includes the passage of a period of time, such as the time since the token identifier was generated or added to said Merkle tree.

27. The system of claim 25, in which said expiration criteria includes a value related to the number of identifiers in said Merkle tree.

28. The system of claim 25, in which said token also has a second identifier such as a serial number that is disclosed prior to or concurrently with said token being used as the subject of a subsequent action; and in which said second identifier is placed into a list or index after disclosure; and in which said second identifier also expires and is removed from the second identifier list after or concurrently with said token's first identifier being removed from said Merkle tree.

29. The system of claim 28, in which second identifiers that are removed from the second identifier list continue to be stored in a record such as a blockchain and are placed into one or more Bloom filters that may be to determine if a second identifier exists in the stored record.

30. The system of claim 29, in which second identifiers are inserted into a Bloom filter until approximately half of the bits in the Bloom filter are set, at which time a new Bloom filter is created and newly expired second identifiers are inserted in the new Bloom filter.

31. The system of claim 29, in which second identifiers are inserted into a Bloom filter until a fraction from 0.4 to 0.6 of the bits in the Bloom filter are set, at which time a new Bloom filter is created and newly expired second identifiers are inserted in the new Bloom filter.

32. The system of claim 29, in which second identifiers are inserted into a Bloom filter until a fraction from 0.3 to 0.7 of the bits in the Bloom filter are set, at which time a new Bloom filter is created and newly expired second identifiers are inserted in the new Bloom filter.

33. A token tracking system comprising: a generator in which token identifiers such as commitments are generated; and in which some participants, including one or more computer systems, place the identifiers in a Merkle tree in a definite sequence A of tree leaf locations; and where, if token identifiers are removed from the Merkle tree, the participants remove them in a definite sequence B which may or may not be the same as sequence A; and where a participant may use a query C at time D to retrieve from a computer system the location of a particular token's identifier E in the Merkle tree and the hash inputs for the path from identifier E to the tree root; and where the participant may use a second query F at later time G to query a computer system to determine the location H at which an identifier was last added to the Merkle tree and the location I at which an identifier was last removed from the Merkle tree; and where the participant may then compute the set J of path inputs in the Merkle tree for identifier E that have changed from time D to time G; and where the participant may then use a query K at time L to retrieve from a computer system the changed path inputs J along with the location M at which an identifier was last added to the Merkle tree and the location N at which an identifier was last removed from the Merkle tree; and in which if M is different than H or N is different than I, then the participant may compute the set O of path inputs in the Merkle tree for identifier E that have changed from time D to time L, and if set O is different than set J, then the participant may repeat query K with set J until the set of changed paths is the same for consecutive queries; and in which the participant then computes the inputs P along the Merkle path for identifier E and uses those inputs in a zero knowledge proof to prove the identifier E is a member of the set of identifiers in the Merkle tree.

34. A token tracking system comprising: a transaction module, in which a transaction or message A to transfer or assign a token must be accompanied by a proof B that the sender knows a secret value; and in which a voting system is implemented by making a copy C of the state D of the system at an instant in time; and in which one or more transfer or assignment destinations E are established that correspond to the votes that a token holder may make; and in which a token holder may cast votes by sending a transaction or message F to the system that transfers or assigns the token to one of the destinations E; and in which the message F includes an identifier G that the message is intended as a vote; and in which the system acts on messages that include the identifier G by modifying the copy C of the system state and not the original system state D; and in which votes are tallied by counting the sum of the token amounts transferred or assigned to each of the destinations E.

35. The system of claim 34, in which the proof B includes a zero knowledge proof.

36. The system of claim 35, in which the system state D is recorded in a blockchain.

37. The system of claim 34, in which the proof B includes a digital signature.

38. The system of claim 37, in which the system state D is recorded in a blockchain.
